(19) United States
(12) Patent Application Publication
(10) Pub. No.: US 2012/0223048 A1
(43) Pub. Date: Sep. 6, 2012

(54) System for Fabricating a Pattern on Magnetic Recording Media

(75) Inventors: Ajit Paranjpe, Basking Ridge, NJ (US); Todd A. Luse, Kings Park, NY (US); Roger P. Fremgen, Northport, NY (US); Narasimhan Srinivasan, Port Jefferson Station, NY (US); Boris L. Druz, Brooklyn, NY (US); Katrina Rook, Huntington Station, NY (US); Adrian Celaru, Hauppauge, NY (US)

(73) Assignee: VEECO PROCESS EQUIPMENT INC., Santa Barbara, CA (US)

(21) Appl. No.: 13/392,246

(22) PCT Filed: Aug. 26, 2010
(86) PCT No.: PCT/US10/46783

§ 371 Date: May 18, 2012

Related U.S. Application Data
(60) Provisional application No. 61/237,141, filed on Aug. 26, 2009.

(51) Int. Cl. G11B 5/84; B44C 1/22; B05C 13/02

(52) U.S. Cl. 216/22; 156/345.55; 216/41

(57) ABSTRACT

An inline processing system for patterning magnetic recording layers on hard discs for use in a hard disc drive. Discs are processed on both sides simultaneously in a vertical orientation, in round plate-like holders called MDCs. A plurality (as many as 10) discs are held in a dial carrier of the MDC, and transferred from one process station to another. The dial carrier of the MDC may be rotated and/or angled at up to 70° from normal in each process station, so that one or a plurality of process sources may treat the discs simultaneously. This configuration provides time savings and a reduction in the number and size of process sources needed. A mask enhancement process for patterning of magnetic media, and a filling and planarizing process used therewith, are also disclosed.

### FIELD OF THE INVENTION

This invention relates to the fabrication of magnetic recording media, in particular rigid and hard disk media onto which magnetic recording material is deposited and patterned into discrete magnetic domains. More particularly, this invention relates to the integration of several processing steps within a single integrated processing tool for the production of patterned media.

### BACKGROUND OF THE INVENTION

Conventional hard disc memory storage uses a continuous magnetic film (aka continuous media), recording information onto the film by orienting the magnetization of small clusters of its metal grains into individual domains, or bits. This “continuous media” technology has physical limitations for memory density, since, as the domains become smaller, their influence on each other increases, and an unacceptable level of spontaneous switching occurs under even small thermal influences, a physical effect called “super-paramagnetism.”

Modern electronics continually raise the absolute volume requirements for data storage, while the space allocated for data storage remains the same, or gets smaller. Solid-state memory, while very dense, is still roughly two orders of magnitude more expensive, per bit, than magnetic memory.

Over the years, the continual increase in data storage requirements has led to steady increases in “areal density”—the number of magnetic domains per unit hard disc area. This has required significant reductions in the average grain sizes of the magnetic films used, and the use of materials with higher magnetic anisotropy and coercivity in order to overcome the super paramagnetic limit These increases in coercivity require higher field strengths to write the bit, which strains the capability of the writer in the thin film head to its limits. Ultimately, there is a limit to the maximum coercivity of the media that can be successfully written with conventional heads, so alternatives must be pursued.

One alternative approach for perpendicular recording media that has been proposed is to continually grade the coercivity of the media from a softer material close to the writer media interface and substantially higher coercivity away from the interface. Such designs are now being introduced and are expected to allow achievement of areal densities of 700-800 Gb/in².

Another approach being investigated is to use thermally-assisted, or microwave-assisted recording. This technique uses localized heating to temporarily reduce the coercivity of the media during the writing process. This is accomplished with a thermal or microwave pulse that is synchronized with the writing process. Various forms of thermally assisted recording are now being pursued in R&D labs and are likely to be introduced in commercially available products by 2012.

In addition to the super-paramagnetic issue, increases in areal density lead to cross track interference that degrades the signal-to-noise ratio (S/R) to the read head. This is a result of the media between the tracks, and limits the areal density that can be achieved. Newer read head designs include novel shielding that minimize this cross track interference, but these require continually lower flying heights, limiting the ultimate extendibility of this approach.

To increase areal density beyond about 800 billion bits per square inch (800 Gb/in²), the magnetic domains of the recording layer can no longer be continuous, but must be patterned into physically discrete domains. This can be partially accomplished by patterning the film into continuous tracks without magnetic media between them, thus greatly reducing the magnetic coupling between adjacent recording tracks. An alternative is to demagnetize the regions between the tracks so that the magnetic grains are magnetically rather than physically isolated. This effectively de-couples the domains in one of two dimensions, requires little or no change to the read/write head technology, and allows the areal density to be increased to roughly one trillion bits per square inch (1 Tb/in²). Beyond that, further increases in areal density require the tracks themselves to be cut and patterned into discrete domains, or bits. This will allow the use of higher coercivity materials and hence improve signal strength, even as smaller magnetic domains are produced. It will further allow areal density to be increased to a physical limit of about 6 Tb/in². Thus, the staged introduction of patterned media is expected to allow 30-40% compound annual growth in magnetic storage densities between 2009 and 2014.

The patterning of media to create discrete tracks, and eventually to create discrete bits, introduces several new process steps into the fabrication of the hard discs. New processing sequences, some involving wholly new techniques from beginning to end, are being explored, but the most promising techniques simply insert new process steps into the existing production line.

In these simpler cases, the continuous magnetic film is coated with masking material, such as a photoresist. A patterned stamp is then used to imprint the pattern of nanoscale tracks or bit domains into the masking material. Production systems that apply the photoresist and use nano-imprint technology to imprint the pattern into the photoresist are already marketed by companies such as Molecular Imprints, Obducat, and EV Group.

The imprinted mask pattern then needs to be transferred to the magnetic film beneath. This may be done by all or some of a series of subtractive and/or magnetically disruptive processes, such as reactive ion etching (RIE), ion beam implantation, ion beam etching (IBE) and reactive ion beam etching (RIBE). If the pattern transfer technique leaves the disc surface uneven, then the unevenness must be filled and smoothed so that it will not impart unacceptable vibration into the read head that flies a few nanometers over it during use. Thus, the disc may need to have the pattern filled and flattened smoothly. Once smoothed, the disc is finished with a protective overcoat, such as diamond-like carbon, and a thin lubricant film.

The challenge for those converting an existing hard disc production line from continuous to patterned media is both technical and economic. If the cost is too high or the floorspace requirement is too large, patterned media will only be selectively adopted, or not at all. Present indications are that the incremental cost/disk for adding all the patterning steps must be under $1/disk for this approach to be cost effective. New tooling will be required to apply a mask layer, imprint patterns, transfer the pattern to the magnetic media, remove the masking layer, fill the gaps between the domains, and smooth, or “planarize” them as necessary. The new tooling will add to the cost per disc, but within a short time of adoption, should not add to the cost per bit. In cases where conventional processes are being upgraded, this new processing equipment must fit into factories that may have little extra room, so it must be compact. Meeting these challenges will be essential to the adoption of patterned media, and by extension, to the continued growth of the electronics industry.

What is needed is an economically efficient processing solution that integrates as many of the new process steps as possible on one platform, in as little space as possible, at a processing rate that is compatible with production flow in currently operating hard disc manufacturing lines, and can be utilized for high volume production of both discrete track and bit patterned media.

Although there exist no prior art systems for particular use in making patterned media, there are processing systems that use industry-accepted means for achieving the conventional continuous media processing requirements. An example of such as processing system architecture is shown in FIG. 1 As shown in FIG. 1, the system includes a substrate transfer system 2, and a linear series of process modules 4 forming the processing unit 6. The substrate transfer system 2 includes a front end 8 with a loading station 10 that accepts cassettes 12 of substrates 14 for processing and an unloading station 16, where cassettes of processed substrates are unloaded. Another example of a processing system is shown in FIG. 2, with rotation modules 18 that are used to change direction of the linear path of the system. In this example, the direction is changed four times to bring the processed wafers back to the same area where they were loaded. FIG. 3 shows a typical disc carrier 12 with two disks 14.

The linear processing systems used in conventional hard drive disc manufacture are typically configured as “inline” systems, through which discs are conveyed while in a vertical orientation with processing occurring on both sides of the disc simultaneously as they move through each processing position. Examples of the technology in use today are described in U.S. Pat. Nos. 5,215,420 and 5,425,611, and embodied in, for example, systems marketed by Intevac, Inc. of Santa Clara, Calif., as the MDP-250 and 200 Lean systems.

Several expired patents show the general features of inline vacuum processing system technology.

In 1966, S. S. Charschan, et al. were awarded U.S. Pat. No. 3,294,670, assigned to Western Electric Company, Inc. It disclosed an inline vacuum coating system with entry and exit loadlocks for one-sided vertical processing of thin substrates for integrated circuits. The system comprised linked vacuum processing chambers and an interconnecting track for transferring substrate holders in sequence from one chamber to the next. FIG. 12 of this patent disclosure shows one embodiment in which the arrangement of chambers doubles back on itself, forming a U-shaped path allowing the entry and exit loadlocks to be positioned adjacent to one another. This patent, filed in October 1963, thus disclosed the following: vertical processing of substrates in an inline vacuum system of connected process chambers, terminated at each end with atmosphere-to-vacuum locks, and with rotated or folded path.

Inline systems are typically loaded at one end and unloaded at the other, but some innovative designs, for example as shown in FIGS. 1 and 2, have been introduced that allow the line of processing to be turned and brought back to the vicinity of the loading area, so that discs are loaded and unloaded in nearly the same place. This has advantages for factory flow management and space utilization. Examples of this are described above and in U.S. Pat. Nos. 6,027,618, 6,228,439 B1, and 6,251,232 B1, and embodied in the systems marketed as the C-3040 by Anelva Corporation of Fuchu, Japan. With similar objective, Intevac markets an in-line system with stacked processes, called “200 Lean”, described in U.S. Pat. No. 6,919,001 B2, that reduces the floor space requirement by stacking two levels of inline processes, and providing means for the disc carriers to be transferred between the levels.

In 1981, R. B. Love was awarded U.S. Pat. No. 4,274,936, assigned to Advanced Coating Technology, Inc. It disclosed a large scale inline architectural glass coater, in which glass substrates are transferred in the vertical orientation through an inline series of gate-valve separated process chambers terminated at each end with atmosphere-to-vacuum locks. It discloses the use of symmetrical processing—two sides of a sputter cathode were used to simultaneously coat two pieces of glass.

In 1985, Boys and Graves were awarded U.S. Pat. No. 4,500,407, assigned to Varian Associates, Inc. It disclosed an inline processing system. Among other important features of the invention, it transferred disk substrates along a linear path, processed both sides simultaneously, and provided transfer direction changes so that the inline processing path could make a U-turn and fold back upon itself. This last feature allowed the loading and unloading ports to be located side-by-side, and established the “closed-loop” architecture for inline processors, again, as shown in FIGS. 1 and 2.

In 1985, C. B. Garrett was awarded U.S. Pat. No. 4,518,078, assigned to Varian Associates, Inc. This patent, filed for in July 1984, discloses the use of magnetically-coupled drives for actuating work piece transfer in an inline vacuum processing system.

In 1988, D. R. Bloomquist et al were awarded U.S. Pat. No. 4,790,921, assigned to Hewlett-Packard Company. It disclosed an inline vacuum processing system for coating both sides of disks. It used a rotating multiple disk carrier, in which disks had an induced secondary, or planetary motion. This secondary rotation was embodied in one of two disclosed ways: in one, the disks rolled around a spindle that went through their center hole, and in the other they rolled inside a groove-edged opening as the entire wafer carrier executed rotations. Thus, the secondary planetary motion was driven by friction, between the spindle and the inside edge of the disk's center hole, or between the disk's outer edge and the retaining groove in which it nested. Both embodiments resulted in the generation of particles due to the friction and rolling motion. The invention utilized a large format multi-metal sputtering cathode, with varying radial composition. This made the secondary, or planetary, motion necessary for film composition uniformity. It established two-sided processing of disks in a rotating multi-disk carrier, in the vertical orientation through an inline series of gate-valve separated process chambers terminated at each end with atmosphere-to-vacuum locks, but does not anticipate the present novel inventive combination, described here.

A “tilt and rotate” technology is described fully in U.S. Pat. No. 6,238,582 B1, awarded to K. E. Williams in 2001 and assigned to Veeco Instruments, the assignee of the present invention, and hereby incorporated into this application by reference.

The in-line systems discussed above are typically loaded with disc carriers bearing one or more discs each. The disc carriers travel through the system without rotation or vertical movement, and thus the processes that affect the discs are designed in one of two ways: to provide either a scanning or a static process. A scanning process is one in which the disc carrier moves, or scans, past the process source, typically a sputtering cathode. In this case, the sputter cathodes will be designed to provide a uniform process across the entire disc carrier. In a static process, the disc carrier stops at each process position and each disc is treated by an individual sputter cathode. In that case, each process position may have as many sputter cathodes as there are discs on the disc carrier. The example of sputter cathodes was used only to illustrate the conformation of the prior art; other processes, such as etching, chemical vapor deposition, and lubricant application have also been incorporated into in-line systems.

The disc carriers of the systems described above, as with any substrate holder used in these types of processes, accumulate process buildup and other residues. Therefore, the disc carriers are often switched out for cleaning, and the cleaning process is typically accomplished somewhere away from the system. This interrupts the full utility of the system, requires manpower scheduling, often some “downtime,” and is a recurring expense.

### SUMMARY OF THE INVENTION

Pattern transfer processes for thin film head and IC manufacturing have very different economics from disc manufacture. In the case of thin film head processing, each finished substrate may be cut into thousands of thin film heads, with only several needed per hard drive. Similarly, many ICs are cut from a single semiconductor wafer. On the other hand, each hard drive requires several whole hard discs. Unlike thin film head processing, which is performed on large substrates 150 mm to 200 mm in diameter, discs are typically much smaller, ranging from 48 mm to 95 mm in diameter. The ratio of number of discs produced to the number of wafers processed for thin film head fabrication could be 10,000:1. Also, in the case of the thin film head or the IC, very small particles may cause unacceptable problems, whereas the recording media of a hard disc is somewhat less sensitive. What all this means is that a process used in thin film head technologies may be expensively over-engineered in areas that have little benefit for recording media applications, and be too slow and expensive as a result, and thus may need to be re-engineered for a much higher level of productivity. This places many more demands on the throughput, reliability, maintainability, and uptime of disc processing tools compared to those used for thin film head or IC manufacturing.

The present invention integrates a suite of processing steps optimized for very high throughput production of recording discs for hard drives, but it may also, in variations, be used for production of other devices.

An object of the present invention is to provide a compact system of linkable process modules that integrate the pattern transfer steps that differentiate patterned media from conventional continuous media.

In order to address the new requirements of patterned media, disc processing systems must integrate processes that transfer patterns. This requires sophisticated etching processes, like those used in the manufacture of integrated circuits, or ICs, on silicon wafers, and at feature sizes (<50 nm) as difficult to work with as those of modern ICs. The issues faced in patterned media disc manufacture differ significantly, however; the magnetic layers are sensitive to the etch process and this limits approaches that may be used.

Previously, the only pattern applied to the disc was in the magnetic alignment of the grains, so the surface remained as physically smooth as the deposited films. The systems cited above were designed to integrate continuous media processes; depositing the magnetic recording layer and all the layers that support and protect it. What are needed now are wholly new pattern transfer systems that can

i.) receive discs with patterned imprinted masking layers already on them,

ii.) deal with the selective removal of masking layer polymers,

iii.) etch the magnetic layers on the discs,

iv.) completely remove the mask and etching byproducts from the disc,

v.) fill etched patterns with a suitably hard, dense material that is compatible with the final diamond-like carbon (DLC) overcoat layer, and

vi.) smoothen the filling layer by selective removal of high points without damaging the magnetic properties of the magnetic tracks or discrete domains, nor removing any substantial amount of the magnetic material.

### I. The MDC (Multi Disc Carrier) Concept

The present invention incorporates rotating round multi-disc carriers (MDCs) that can carry six, eight, ten or more discs at a time in a round “dial” carrier along the same linear path as a prior art one- or two-disc carrier. At each process station, the carriers rotate about their circular axis so that all the discs may be uniformly treated on both sides by opposing large format processing units. An example of one embodiment of the MDC in the present invention is shown in FIGS. 4, 5, and 26-29. Each MDC may be rotated (see arrow in FIG. 4 middle picture) at, for instance, 15 to 300 rpm to allow dynamic batch processing of all the discs in the MDC substantially simultaneously. The rotation is driven by the center shaft of two concentric shafts as seen in bottom of FIG. 28.

In one embodiment of the present invention, multiple substrates on a single substrate holder are processed simultaneously by a large format processing source. Thus, in the present invention, all substrates are continually processed. In other words, a 16 second process is completed in 16 seconds over eight substrates. By contrast, the batch processing of the systems noted above requires 8×16 seconds.

Notably, the speed improvement described above comes without attempting to reduce process duration, as reducing process duration can increase variability. As one example, power supplies that control sputtering cathodes must initiate a discharge using over 1000 volts, sense the change in current drawn (I) when the discharge starts, and immediately adjust it based on the characteristic impedance so that the predetermined set-point stable power is reached. Small variations in discharge initiation and automation control accuracy typically introduce an error of 0.5 seconds or more—which is 12.5% of total process time, in the case of a 4 second process, but far less in the case of a 16 second process such as described above. Also, during the initiation of any plasma process, gas heating and expansion will cause changes to pressure gradients and gas flow within the process volume. These changes eventually stabilize, within a timeframe of less than one or two seconds if the module is well-designed. During this period, however, the characteristics of the process will fluctuate and the process itself may be incapable of repeatable delivery within specifications. A movable shutter may be employed between the process source and the substrate so that stabilization can take place without affecting the substrate, but the opening of the shutter also introduces a stabilization period. If the process involves the use of reactive gases, the process transient to reach steady state processing is typically longer compared to processes that utilize inert gases because of the added time required to stabilize the composition in the gas phase. If substrate heating or cooling is involved this adds to the total processing time or requires that the heating or cooling be performed in a separate chamber if a very short total processing time is to be maintained. Finally, for precision etching and deposition processes, a sequence of sub-steps is often necessary to accomplish the desired goals which increases the total process and overhead time.

This stabilization time requirement is different for different chamber designs and processing recipes, but exists in all processes of this type (i.e., sputter, etch, chemical vapor deposition, IBE, RIBE, etc.). This is a significant factor limiting throughput in any system, but most markedly in single-substrate processors. The processing time must always have the fixed stabilization time added to it, and this becomes proportionately larger as processing times are shortened. A process that takes 16 seconds and has a stabilization time of 1 second will suffer a 4× increase in variation if the processing time is shortened to four seconds. For example, in a 10 nm film deposition process, one substrate could receive 9 nm of deposited material and the next get 11 nm This variation is compounded by the uniformity standard over the wafer, typically +/−5%.

In an embodiment of the present invention, the entire MDC is processed as if it were a single large substrate. Accordingly, six to ten substrates are processed at one time, and the time required to complete the process may be lengthened to reduce the significance of the variations noted above. If, for instance, an MDC holding eight substrates was processed in 16 seconds, then the effect of the errors noted above may be reduced by a factor of four, from +/−1 nm to +/−0.25 nm

As an added benefit, the throughput may also improve. For example, eight substrates finish processing in 16 seconds, and then transfer together in 4 seconds to the next processing step. In the transfer operation, pressure is equalized between two process modules, a gate valve is opened, and the substrate carrier is moved from one process module to another. These operations would disturb any processes being performed in the involved process modules, so transfer operations are only started after the process in both modules is completed. The amount of time required to transfer a substrate carrier, whether it holds one or eight substrates, is fixed, but the per substrate transfer time is eight times greater in the case of the single substrate carrier. This leads to a per-substrate step duration of 2.5 seconds (16+4 divided by 8). By contrast, in a system with four times the variation in process, as explained above, has a per-substrate step duration of 8 seconds (4+4 divided by 1), making it over three times slower.

The MDC may include a dial carrier holding the substrates, and the dial carrier may be rotatable within the MDC. Since clean processing is essential, the MDC dial carrier may be supported by an ultra-clean vacuum-compatible bearing around its periphery. Ultra-clean, vacuum-compatible bearings developed for various semiconductor applications may be utilized. Some of these use a combination of ceramics and vacuum-compatible plastics for minimal particle generation. The bearing is buried within the rim of the dial carrier of the MDC so that all contact surfaces are completely shielded from the process environment. A magnetically levitated bearing may also be employed. Such bearings typically require a combination of permanent and electromagnets for active control and stability of the bearing. A seal that initially has an interference fit and made of a low coefficient of friction, abradable material may be used, and after running in the seal, it eventually becomes a non-contacting seal with a minute gap to the rotating portion of the MDC, thereby preventing the egress of any particles generated in the bearing into the process space.

The spinning of the MDC dial carrier may be driven by a variety of drives such as a bevel gear drive, a capstan drive, or more preferably a magnetically-coupled drive located at the edge of the dial carrier. Alternatively, the dial carrier may be supported through its center hub similar to a Ferris wheel and then driven through the center hub or the edge drive. In the case of a magnetically coupled drive, permanent magnets may be embedded in the outer periphery of the dial carrier which would magnetically engage with a magnetic rotating shaft.

In situations where the rotational speed of the dial carrier is not critical for the process performance, the rotation drive may engage only intermittently with the dial carrier to spin it up to the desired upper rotational speed. With process times typically in the range of 10-60 seconds, rotational inertia may keep the dial carrier spinning at an adequate rate. In this case, the rotational drive may be co-located within the process module or in a region between adjacent process stations.

Capacitively coupled radio-frequency power in the range of 100 kHz-40 MHz typically may be applied to the discs, via the MDC, by applying that power across the thin gap formed by the magnetic bearing, thus facilitating “bias voltage” generation at the disc surfaces when such application is beneficial.

For certain processes where continuous or pulsed DC bias is required, the bias may be applied via a rolling contact. In cases where the dial carrier does not rotate the substrates, the contact may be made by a retractable periphery contact or a bayonet type contact to the face of the MDC.

Bias on the MDC may also be induced by applying low frequency (100-400 kHz) RF power to a secondary electrode in the vicinity of the MDC. For a sputter etch module, this secondary electrode could be either the counter electrode or a secondary electrode of a triode etch system. For a sputtering system, the RF power would be applied to the target assemblies facing the MDC. In both cases, the low frequency RF would likely have to be superimposed on the primary RF or DC power required to sustain the primary plasma. For a given RF power, induced bias is typically lower than bias directly applied but the advantage is that it completely avoids electrical contact to the MDC and thus would be effective even when the MDC is rotating. The best method for applying bias is application and chamber configuration dependent.

The MDC dial carrier can also be rotated step-wise through accurately indexed positions, so that each disc may treated individually in cases where static individual treatment is preferable, such as, for example, cooling or heating. The MDC disc carrier is indexed so that positive positioning to within 0.5° may be attained for alignment with temperature transition panels (described below, in section iv.).

The MDCs are transported through the system on MDC carts which ride on linear rails or tracks. The linear motion between process stations can be accomplished via conventional mechanical means such as belts, conveyors, push-rods, etc. or preferably by a magnetically coupled drive such as a magnetic linear motor.

At each process station, one or more drives engage with the MDC cart to provide the rotation or indexed step-wise motion of the MDC. In addition, the drives may also be used to rotate the carrier about a vertical axis to tilt the plane of the carrier in the range of 0-70 degrees relative to the sources in each of the process stations. This tilt is visible in the top of FIG. 28. The tilt can also be accomplished by rotating the rail about a vertical axis within the process station. A number of different methods can be employed to tilt the MDC including a rotational drive for continuously variable tilt. For a fixed, pre-defined tilt, a cam engages with the cart as it is moved linearly into position within the process station, and a similar method is used to return the tilt to 0 degrees as the cart leaves the process station. As seen at the top of FIG. 28, the outer shaft of the two concentric shafts has a follower arm with a roller at the end. The roller fits into a groove in the profiled rail. As the cart is moved linearly, the distance from the centerline of the shaft to the groove changes, applying pressure to the roller. This in turn rotates the outer shaft changing the tilt of the MDC. If the fixed tilt in the chamber is to be adjusted, the angle of the follower arm that engages the cam profiled rail may be adjusted relative to the tilt axis (the vertical axis, as illustrated). Alternatively the cam profiled rail may be moved in the axial direction. The latter may be preferable if adjustable tilt is required. Although the preceding description refers to vertical, it is also contemplated that the system may be arranged in other orientations, so that the carrier may be rotated about a corresponding axis to achieve the equivalent tilt.

The multi-disc “batch” processing enabled by the MDCs reduces the number of transfer steps per disc by at least twice and as much as four times, reduces the number of disc carriers per disc that must be cleaned periodically, increases overall processing throughput (discs per hour), throughput per square foot of floor space, and throughput per dollar of capital equipment cost.

### II. Universal Process Modules

Incorporated in the present invention are “universal process modules” that are separated from one another by rectangular vacuum gate valves, such as those sold by VAT, Inc., and MDC Corporation. Such valves are common in the vacuum processing industry and familiar to anyone involved in the design or use of these systems. The universal process modules can accept a wide range of process technologies for treating the discs, including very large ion beam sources that operate with and/or without mixtures of reactive gases to physically and chemically etch masking polymers, magnetic layers, and gap filling layers. They can also mount very large magnetrons, inductively-coupled plasma (ICP) sources, ion implantation sources, chemical vapor deposition (CVD) sources, atomic layer deposition (ALD), plasma enhanced chemical vapor deposition (PECVD), misted chemical deposition (MCD), remote plasma sources, and cathodic arc sources to process the discs as required.

Alternately, the universal modules can be mounted with arrays of similar smaller process sources that treat the discs in repetitive sequence as they are rotated past on the MDC. Because of the adaptability of its mounting flanges, the universal module may also be configured to accept atmospheric pressure processes, including various misting, vapor phase, and aerosol technologies that rely on condensation to deposit materials and material precursors onto the discs. These include wetting agents, lubricants, spin on glass, spin on polymeric materials, and various atmospheric or sub-atmospheric CVD precursors. One option is the Flowfill™ process involving the condensation of hydrogen peroxide on the substrate surface and the subsequent reaction with silicon containing gases such as silane. Another possible approach is to condense silanol like materials on the surface and, subsequently react polymerizing agents such tri-methyl aluminum, an aluminum hydride, with them. These materials form various silicon dioxide glass layers suitable for trench and gap fill on patterned media. Other sub-atmospheric processes that are useful in media manufacturing include vapor phase etching using anhydrous HF/alcohol mixtures, and vapor phase cleaning using supercritical fluids such as CO₂ snow or cryosols. CO₂ snow and mists of volatile liquids may also be directed towards the disk in order to cool the disks without physically contacting the disks.

Machined recesses surround the track in each universal process module. The machined recesses are designed to allow a spuriously dropped substrate to fall completely out of the way of all moving parts. An opening may be provided in the chamber to quickly and easily remove all debris from the base of the chamber, which if allowed to accumulate, could damage the transport system and become a source of particles. A sensor, such as a cut-beam sensor, checks the MDC for missing substrates after each processing and/or transfer step.

The universal modules incorporate the mechanisms for linear motion, MDC rotation and tilt as described above. Since the rail or track for linear motion must be interrupted at the vacuum gate valves on either side of the universal process modules, provision is made for the MDC cart to smoothly transition from the rail or track in one module to the rail or track in the next module. One method is for the cart to be long enough so that its front end engages with the track in the following module before its center of gravity passes over the edge of the track in the previous module. Good alignment between the rails in adjacent modules aids proper operation. Optical and mechanical techniques that are commonly used for alignment of rails or structures over long distances may be used or built into the chambers for ease of alignment.

During normal operation, all the stations will be occupied by carts. Thus a motion control system that synchronizes and schedules the movement of the carts from one module to the next without interference is required. Linear motion systems with embedded controllers are available from companies such as Magnemotion and Bosch Rexroth. The motion could be synchronous or asynchronous. An example of asynchronous would be if the carts downstream of a process module are indexed by one station, while the carts upstream of the process module remain in place. This allows a cleaning or conditioning step to be performed in a process module without a cart being present in the chamber.

In addition to the process sources, the process modules are equipped with the requisite process gas delivery system, vacuum pumping system that may be a combination of dry and high vacuum pumps (e.g. turbo-molecular pumps, cryogenic pumps, water pumps, and the like), pressure gauging, chamber wall temperature control, shielding to protect chamber surfaces from the process environment, and an electronic/software control system. The specific design features of each universal module depend on the processes being performed within the module.

### III. Pressure/Atmosphere Transition

The universal module may also be configured to provide pressure and atmosphere transitions between processes. For example, it may accept an MDC at vacuum and transition it to a high pressure environment, such as atmospheric pressure nitrogen, or vice versa. This ability to broadly transition pressure allows the present invention to perform vacuum processes and atmospheric processes on the same discs during a single automated pass through the system. This ability may be utilized, for instance, to treat discs that have had pattern transfer etch and would then need to be coated with a filling layer using a mist, vapor, or aerosol technology that requires higher pressure to accommodate condensation of material onto the discs. The transition between atmospheric and vacuum processes can be accomplished within a single chamber placed between process stations, or by a sequence of chambers with each chamber operating at a different vacuum level. The number of chambers and the vacuum levels within each chamber are determined by the throughput, cleanliness and intra-station cross contamination requirements.

### IV. Temperature Transition Modules

The universal module may also be configured to provide the discs with temperature transitions. In one embodiment of the present invention, thermo-electric ceramic (TEC) panels are provided that may be brought into close proximity of the discs to facilitate radiant, conductive (through a thin amount of a high conductivity gas, as will be described) and convective cooling or heating. The TEC panel array is illustrated in FIG. 5. These thermoelectric panels are similar in shape to the discs and may be arrayed on their holder so that each disc in the MDC has a thermoelectric panel set close to either side of it during temperature transition. The two-sided cooling process thus configured may cool a disc from 100 C to below 0 C in less than 20 seconds, or may heat the discs over a similar range of temperatures in a similar amount of time. This transition may be accommodated on a universal module that also transitions the discs from one pressure and atmosphere to another. For example, discs that have just completed pattern transfer etching at vacuum may be hotter than the optimal temperature for the next process, which might need to be done at atmospheric pressure in a nitrogen environment.

In order to achieve heat transfer rates between the TEC panels and the discs, a narrow gap between the TEC head and the disc is filled with a high thermal conductivity gas such as helium at pressures between 1 and 50 Torr. Lower surface temperatures on the TEC will also increase the cool-down rate, but it should also be considered that about −20° C. is the low temperature limit for many of the polymeric materials that are used as masking layers. Similarly, when the disc has to be heated to a certain temperature prior to processing, the disc temperature should not exceed its upper temperature limit which is 175-200° C. for most advanced media today.

Cooling may be further accelerated by injecting chilled gas into this cavity if the pressure in the cavity is sufficiently high and convective heat transfer plays an appreciable role in the disc cooling process.

An alternative to chilled gas is the use of evaporative cooling in which a mist of a low boiling fluid with high latent heat of vaporization is sprayed on to the surface of the MDC. Several refrigerants (fluoro-inerts) are suitable, but since many of these are expensive and cannot be discharged to the atmosphere without adequate scrubbing, a closed loop system that reclaims, filters and re-uses the refrigerant is typically necessary. Cheaper volatile fluids with high latent heat of vaporization such as isopropyl alcohol that can easily be abated in a burn box may also be used. The use of CO₂ snow for cooling is another option as discussed before.

In lieu of the TEC cooling plate embodiment, MDC cooling may also be accomplished by contact with turbulent gas flow. The MDC, with its unique ability to spin, will generate drag induced vortex turbulence in the presence of adequate gas pressure. These conditions are met by using a low-volume chamber with parallel cooled plates adjacent to both sides of the spinning MDC, at 5 to 10 mm distance. A suitable gas is used as the primary thermal carrier, introduced under pressure near the spinning axis of the MDC to allow rapid expansion and cooling, until the volume containing the spinning MDC is at a pressure in the tens of Torr range, or greater. Each parallel plate carries, on its MDC-facing side, a pattern of machined grooves and striations designed to increase drag between the gas, the spinning MDC, and the plate, thus breaking up laminar flow, inducing turbulent flow, and facilitating efficient heat transfer.

This latter embodiment of the present invention utilizes the MDC to accomplish temperature transition without the necessity for very small tolerance gaps between the discs and the heat exchange plates. This is a significant advantage that reduces cost and improves process repeatability.

For turbulent cooling, where high bulk gas velocities play an important role, heat transfer may be substantially faster than in conventional cases involving stagnant or low bulk gas velocity. Helium, traditionally used in heat transfer between wafers and cooling or heating pedestals, may be diluted with a much less expensive noble gas, as taught by M. R. Vanco in NASA TN D2677 (1965). In fact, under turbulent conditions, these binary mixtures may outperform pure helium by as much as 40%, in the case of a 20:80 molar ratio of Xenon and Helium. The He portion may be further diluted with H₂, by as much as 25%, for a final molar ratio of Xe:He:H₂ of about 20:60:20, without being combustible. In this way, the heat transfer gas mixture may outperform pure helium while providing significant cost reduction.

Similarly, super-cooled gases may be introduced to provide even more rapid cooling of the substrates.

In both above cited embodiments of the present invention, such carrier gas or gas mixtures may be recaptured, recharged, and re-stored at high pressure in one or more small chambers adjacent to the parallel cooling plates. In the case of super-cooled gases, they may also be re-chilled. At the beginning of a substrate cooling cycle, valves separating the cooling station from the higher pressure gas storage chambers are opened, allowing the carrier gas to expand rapidly into the volume containing the plates and the spinning MDC. Such rapid expansion reduces the energy of the carrier gas, cooling it.

The parallel cooling plates are formed from the chamber sidewalls, with heat dissipation vanes machined into their outside surfaces to facilitate ambient air cooling. Alternately, they may be actively cooled by circulating a chilled liquid coolant, such as water.

With reference to FIG. 6, in the following operational sequence example these initial conditions pertain:
All 5 Valves are closed.
The “Cooling Station” is at operational transfer base pressure, between 10⁻⁶ and 10⁻⁵ Torr, and has a volume of 10 liters (for example).
The “Vacuum Buffer” contains carrier gas at a pressure of 1 Torr, and has a volume of 100 liters (for example).
The “Pressurized Gas” vessel contains carrier gas at a pressure between 100 and 10,000 Torr, and has a volume of 1 liter.
The “Turbo” pump is spinning at full RPM, with a foreline pressure of 2 Torr.
The dry “Pump/Compressor” is idling with 2 Torr input and up to 10,000 Torr between its back and Valve #4.

Sequence of operations:
1. MDC enters Cooling Station, spins up while both gate valves close. Valve #5 OPENS to allow carrier gas entry and pressure rise to setpoint.
2. MDC spins up to 30 or more RPM as carrier gas expands rapidly into the Cooling Station from the pressure vessel.
3. Carrier gas pressure in the Cooling Station reaches a pressure setpoint between 10 and 50 Torr, Valve #5 CLOSES.
4. The MDC spins in the carrier gas, cooling to a temperature setpoint value, or until a set time has passed.
5. Concurrently, Valves #3 and #4 OPEN and the Pressurized Gas vessel begins to recharge, using the carrier gas in the Vacuum Buffer, fed through the Turbo.
6. When the cooling process is complete, as determined by temperature measurement or fixed time setpoints, Valve #3 CLOSES and Valve #1 OPENS, causing the Cooling Station gas pressure to drop to about 1-2 Torr within about 3 seconds, depending on conductance.
7. Valve #1 CLOSES and Valve #2 OPENS. The Cooling Station is pumped to operational transfer base pressure, between 10⁻⁶ and 10⁻⁵ Torr.
8. Valve #2 CLOSES, Valve #3 OPENS, and the recycling of carrier gas is completed as the MDC transfers out of the Cooling Station, the next MDC transfers in, and the gate valves close.

Pirani-type gauges monitor the Vacuum Buffer vessel, the Turbo foreline pressure, and the Pressurized Gas vessel. On each cycle, a small amount of carrier gas is lost; this is compensated by periodic supplementation at either the Vacuum Buffer or the Pressurized Gas vessel. For instance, if the Pressurized Gas vessel fails to reach a given setpoint via the recycling of gas through the compressor, this may trigger “topping off” through a check valve set to the proper pressure, connected to a bottle of pressurized gas.

In the schematic representation of FIG. 6, the connection between the Cooling Station and the Vacuum Buffer vessel is a thin line, but the actual connector would have a cross-sectional area large enough to provide the gas flow needed to equalize pressure between the two chambers in less than 3 seconds. For instance, this connector may be formed from 30-mm diameter tubing, or even 100-mm diameter tubing, with Valve #1 an equally large electrically or pneumatically actuated gate valve. Similar actual dimensions apply to the connections associated with Valve #2 and Valve #3.

### V. Process Tilting

Ion beam angle-of-incidence has an important impact in ion beam etching (IBE) and reactive ion beam etching (RIBE) processes for “sputter” removal, which will now be explained.

When a surface is struck by an incident ion, there is a loss of some or all of that ion's energy. A portion of the lost energy is absorbed as vibration and becomes heat, but a fraction of it is transferred to atoms that are ejected, or “sputtered,” from the surface. The ratio of sputtered surface atoms to impacting ions is called the “yield” and is typically a strong function of the angle formed between the impacting ion and the surface. At “normal” incidence, when the ion strikes at 90 degrees to the surface, the yield may have a value of 1, but at 60 degrees off of normal incidence this number may be as high as 1.8. An 80% increase in yield, for the same energy ion, has obvious importance to IBE users. In the case of reactive ion beam etching (RIBE), the significance of angle-of-incidence is also great; reaction rates between surface atoms and chemical species in the ion beam are strongly coupled to the sputtering that is concurrently taking place.

In etching applications, a surface may have a pattern of two layered components; one that is to be removed, and one that is to remain. In such a case “selectivity” is required. An IBE process has selectivity if it acts on one component of the surface more aggressively than on the other. It is well known to those practiced in this art that some materials have much higher sputter yields than others, and also that some materials have much stronger changes in yield as the angle-of-incidence of the ion beam on their surface changes. “High selectivity” for one component means that it will be removed much more quickly than the other, perhaps by a factor of 100. For instance, there is a large selectivity difference between the photoresist used as the masking layer and the Co alloys used as the storage layer on a hard disc, especially as a function of angle-of-incidence. This selectivity is also a property that can be used to advantage in planarizing the trench filling layers; at steep angles the etch rate can double, so the ion beam tends to remove the high points faster than surface depressions, thereby flattening the film profile. A combination of angles may be used in ion beam etch in order to achieve the desired selectivity, etched profile, final surface roughness, and reduce the problem of re-deposition.

At any point on a round substrate, such as a magnetic storage disk, there may exist a structure, such as a recording track or a discrete bit, that is a raised structure rising out of the surface. If this structure is created using an IBE process, and especially if it is created by removing material from around it through an angle-of-incidence selective IBE or RIBE process, then several important issues must be addressed. First, in order to have angle-of-incidence effects act on this structure (and its sidewalls) uniformly, the ion beam must somehow rotate about the normal of the structure, bringing the incident ions into contact with its top and sides while preserving the desired angle-of-incidence. This first issue is addressed by tilting and rotating the substrate in the ion beam, but it raises the second issue: the ion beam's density and energy must be isotropic as it acts on all sides of the structure. Keeping in mind that as the tilted substrate always has one side further from the ion source than the other, any beam steering (angle of mean of beamlet relative to the surface normal to the grids) and divergence (angular spread in the beamlet about the steering angle) will lead to an anisotropic treatment of the structure's sidewalls. In a completely divergent beam, the density of ions striking the surface will fall off approximately proportional to the square of the distance from the ion source. This may manifest as an uneven forming of the structure's sidewalls, for instance, and may result in unacceptable shifting of “critical dimensions” or CD. This may also lead to profile asymmetry especially for structures located at the edge of the substrate where the resulting sidewall on the in-board side is steeper or more vertical than the sidewall on the out-board side of the structure. Large angular divergences also may make it difficult to etch narrow high aspect ratio trenches since the beam density at the bottom of the trench is significantly lower than the beam density on the top surface of the trench due to shadowing of the non-collimated beam by the sidewalls of the trench. This results in trenches of different widths etching at different rates. In addition, the bottom of the trench may not be flat. Patterned disks are expected to have structures of different sizes, shapes and aspect ratio especially in the servo region of the disk, so the ability to etch all structures at the same rate with good sidewall angle control is important.

This second issue would make any IBE or RIBE process unsuitable for defining 3-D structures such as discrete tracks or bit patterns, when angle-of-incidence selectivity was required. In cases where the ion beam could be virtually “collimated,” thus eliminating any significant divergence, would such processes work. An exemplary system is shown in U.S. Pat. No. 6,759,807, originally developed and put into production making thin film heads, and incorporated herein by reference. Applied to the present invention, tilted rotating IBE and RIBE technology can deliver an isotropic off-normal process at all points on a large substrate or substrate carrier.

Advanced ion beam grid technology, such as that cited above and incorporated in the present invention, provides a uniform collimated beam over a large substrate, even at a range of distances, or “throw lengths,” from the ion beam source.

Thus, a round substrate, placed so that it sits completely within the collimated ion beam, may: i.) have its axis tilted by an angle θ relative to the axis of the ion source, ii.) receive, at all points on the surface facing toward the ion source, essentially the same density of ion bombardment, and iii.) be rotated about its tilted axis so that each point on its surface will receive the ion beam at a fixed angle θ from normal, and from all azimuthal angles φ. This utilization differs significantly from conventional prior art use.

In one embodiment the present invention, by using a large diameter ion source with a uniform and highly collimated beam, a large rotating substrate, or substrate holder, may be tilted without significant process anisotropy being introduced (FIG. 7). Though it is a unique and novel way to treat one side of a substrate, this novel feature is also extended to two-sided processing in the present invention, by placing an ion beam source on the other side of the rotating substrate or substrate holder, so that both sides receive the same angle-of-incidence processing simultaneously, as illustrated in FIG. 9.

In FIG. 8, the divergent ion beam is represented for comparison, using shading to denote ion beam density at the rotating substrate or substrate holder, as shown. The ion beam is less dense at the substrate in FIG. 7 than it is in FIG. 8. These figures are meant to roughly illustrate the principle, not accurately depict ion densities of these differing sources.

In FIG. 9, the use of opposing large area collimated ion beams is depicted to illustrate two-sided processing according to one embodiment of the present invention.

For physical vapor deposition (PVD), tilting allows tailoring of the surface profile of films deposited on patterned surfaces. Tilting the substrate relative to the PVD source results in preferential deposition of material on the top corners of a trench structure while a configuration in which the target is parallel to the substrate surface leads to increased deposition at the bottom of the trench because it, like the substrate surface, is perpendicular to the PVD source. This control over the step coverage is useful for the mask enhancement process which is described later.

Atomic layer deposition or condensed phase deposition may also be performed on the MDC. A typical process source for this type of process is shown in FIG. 30. Each process source consists of numerous wedge shaped showerheads arranged in a circle. Two process sources on either side of the MDC are brought in close proximity to the MDC so that the outer surfaces seal (or almost seal) to the stationary shielding of the MDC. For ALD Al₂O₃, trimethyl aluminum (TMA) and water are injected through alternating showerhead zones with an inert gas injected in between the TMA and water zones. In addition, inert gas is injected through the center of the process source and around the periphery of the MDC. The TMA and H₂O are pumped through dedicated vacuum pumps attached to the corresponding ports while the inert purge is pumped through both the TMA and H₂O zones. In this manner, the TMA and H₂O are physically isolated from each other except for the reactants that are chemisorbed on the disk surface. A lamp assembly (not shown) heats the disks in the MDC to the desired temperature. One or more lamp assemblies is located in the inert purge zones.

### VI. MDC Tilting

In further extension of process angle-of-incidence advantages beyond the mounting of tilted sources, each universal module has the ability to tilt the MDC up to about 70 degrees in either direction from the linear path of travel during processing. This ability is a great advantage in improving material selectivity for etch, and for selectively smoothing and planarizing the trench and gap filling layers, as noted above. It is understood that either process tilting or MDC tilting or a combination thereof may be used. MDC tilting can be used in conjunction with any of the processing sources described above.

### VII. Transfer/Shuttle Shaft

The disclosed embodiment of the present invention also uses an undercarriage vacuum transfer shaft that allows processed discs on MDCs to quickly transit from the back of the system to the front end unloading station. This is accomplished by a back end station elevator that accepts the MDC after it exits the final process station. The transfer shaft is made up of segments similar to the universal modules, but without processing features and with no need for gate valves between them. In normal operation, the processing level may process up to 140 MDCs per hour toward the back end of the system, which means that one MDC emerges from the last processing station about every 25 seconds or more. Within the 25 second window, an MDC loaded with processed discs may be shuttled to the front end station (3 sec.), have its discs unloaded (15 sec.), be shuttled back to the rear end station (3 sec.), and be transferred to an MDC cleaning module (3 sec.) adjoining that station, thereby fitting this maintenance operation in without interrupting process throughput or system availability. The transfer path may be located under, above or beside the process modules depending on the specific layout. Another option is to stack the modules in the vertical direction so that the MDC transfers between process stations at the upper level in one directions and then traverses between process stations at the lower level in the reverse direction so that it exits the last process station on the same side as it enters the first process station.

### VIII. MDC Cleaning and Storage

In several envisioned embodiments of the present invention, an MDC cleaning module accepts empty MDCs and cleans process build-up and other residues from them. This may be accomplished using chemical plasma processes, jet cleaning with fluids or soft abrasives such as sodium bicarbonate powder, physical processes such as sputter etching or ion beam etching, or other techniques, depending on the nature of the buildup and residues. For disc processing, it is common to use a combination of chemical and physical processes to ensure complete removal of build-up and debris. This process may also involve rotation and tilting of the MDC to improve the effectiveness and completeness of the clean. More than one cleaning station operating in series or in parallel may be utilized to increase the throughput or to perform mutually incompatible cleaning processes. In the cleaning station, sources may be mounted at different locations and angles relative to the MDC to achieve complete cleaning of all surfaces which could otherwise become a source of unwanted particulate contamination.

In the “box” system architecture configuration, the loading and unloading stations may be separated by a pass-through, or “bridge” that is, or is attached to, an MDC Cleaning Station. Alternatively, the cleaning module may be positioned off the back end of the system, or in a branch position enabled by the Intersection Module, described below.

One embodiment of MDC cleaning station has two levels, one to accommodate the actual cleaning process and another to act as an accumulator of MDCs, both clean and prior to cleaning. Because process buildup and residues accumulate to unacceptable levels only after several passes through the system, the MDC cleaning process does not need to be as fast as a disc pattern transfer process. For instance, if the MDC accumulates enough process buildup and residues to require cleaning only after 10 passes through the system, then after its tenth pass it will be unloaded and shuttled back to the rear end station and transferred either directly into the cleaning station, or to the accumulator to await cleaning. A complementary accumulator may be situated adjoining the front end station, and in it stored clean MDCs ready for loading as others are taken out of line for cleaning. In this way, the present invention may be operated without the interruptions common to prior art systems, which are periodically stopped for the removal and cleaning of disc carriers. The cleaning schedule for the disc carriers may be staggered so that each one can be cleaned without affecting the throughput of the system.

In lieu of an MDC Cleaning Module, an accumulator module may be used to collect MDCs as they require servicing. This accumulator may be configured with a carousel rack, or a cassette-style rack. Cassette Loadlocks located on both the substrate loading and unloading stations would be periodically used to i.) bring in fresh loads of clean MDCs and ii.) to send out cassette loads of MDCs that require cleaning.

MDC tracking, by methods such as barcode or RFID, would alert the system when an MDC had been used a given number of times and was due for cleaning and/or servicing. That MDC, upon being unloaded of substrates, would itself be placed into a cassette in its own loadlock adjacent to the substrate loadlock. When almost full, the system alerts the operator of a pending unload operation.

Cassettes full of cleaned MDCs are loaded into the system on the substrate loading side, where a cassette loadlock(s) for the MDCs, similar to the ones on the unload side, exist.

Alternatively, a single MDC cassette loadlock may be used for removing used MDCs for cleaning, and for putting clean MDCs into the system. In this case, the unload station robot will transfer new MDCs to the load station robot as required.

The nature of the pattern transfer process is that a near net zero (total deposition approximately equal to total removal), or a net removal will likely be normal. Nonetheless, small areas of the MDC's substrate holding flexures and fixtures may accumulate process residues or be eroded because of shadowing, and will eventually need to be serviced or replaced. In either case, the flexures and fixtures are screw-in or snap-in parts that may be part of a robotically changeable cartridge. Cartridges comprising a set of mounted flexures and other substrate holding fixtures may be replaced periodically by a robot in the system, thus extending use between external services.

### IX. Vertical Stacking

One embodiment of the present invention also uses optional vertical extensions to the process modules. These vertical extensions are formed by stacking one universal processing module on top of another. In this configuration, the discs on an MDC may receive processing in the upper universal chamber when it is lifted by an elevator mounted in the floor of the lower universal chamber. Utilizing this stacking capability, system footprint may be significantly shortened, or redundant processing capability may be kept adjacent to, and in support of, a single high-maintenance process. Additionally or alternatively, two longer processes may be accomplished in one stacked module if they precede a relatively short duration process in the next module. All of these uses may have highly beneficial impacts on the processing economics for the recording disc manufacturer.

In the embodiments of the present invention, universal process modules may also be mounted as separate parallel processing tracks, both under and/or over the primary middle processing track. This is accommodated in the design by using the processing modules as structural members of each modular segment. End station elevators raise or lower MDCs to each track level.

Other architectures in which a combination of parallel and serial processing is performed can also be considered. In such architectures, for example, there may be redundancy built in for modules that require more frequent servicing so that the system can continue to operate even while one or more of the modules is taken off-line for repair or servicing.

In addition to process modules, some modules may be utilized for in-line inspection or metrology. Information gathered from these modules may be used to interrupt processing if severe fault or scrap events are detected, or the information may be fed-forward or fed-back to other process modules on the same tool or other tools as a part of a supervisory process control loop.

### X. Intersection Chambers

The inline configuration of some embodiments of the present invention may also be adapted to re-route MDCs into sidelines for various reasons, such as processing, sampling, MDC cleaning, or process metrology. The intersection chamber used for this is wide enough to allow full 360° rotation of the MDC about its vertical axis, and may attach universal modules or transfer shaft sections at four positions corresponding to 0, 90, 180, and 270° from any first attachment point. The Intersection Module is illustrated in FIG. 10. This intersection module contains a section of track that aligns with the direction of travel of any incoming MDC, then rotates it about its center to align the MDC with any chosen outgoing direction. This four-sided intersection module may be placed, for example, in a position where a high-maintenance process is performed. Such a process may require maintenance more than those preceding or following it, and would normally require the whole system to be shut down while maintenance was performed. Using the intersection module, identical high-maintenance processes may be mounted opposite each other at 90° to the main line of the system, and alternately used on every other MDC, or, only one of them used until that one required maintenance, at which point processing would be re-routed to the other until it needed maintenance, and so on. In this way, the productivity of the whole system could be maintained while the redundant module was taken off-line for maintenance. Alternatively, the intersection module may be used to mount various metrology stations that can make critical checks of process performance before the next process is performed. Such a metrology station may, for example, use ellipsometry to measure the thickness of a dielectric layer that has been deposited just prior to that point in the processing line. Or, it may serve as a mid-line loadlock, where a process engineer may extract a sample from the processing system for analysis in a laboratory, without interrupting the flow of other MDCs. Or, the intersection module may be used simply to turn a corner, allowing the inline system of the present invention to be laid out in other than a straight-line configuration; for instance an “L”, or a “U”, or even a rectangular or “box” configuration to accommodate floor space constraints.

### SUMMARY

This disclosure describes a high-flexibility inline processing system for transferring patterns onto the magnetic recording layers on hard discs for use in a hard disc drive. The system processes both sides of the discs simultaneously in a vertical orientation as they transfer from one process station to another, holding a plurality of them in round plate-like holders called MDCs that spin so that as few as two process sources may treat as many as ten 65 mm discs at one time, and may work at angles from normal to 70°, resulting in time savings and a reduction in the number and size of process sources needed. The system is comprised of segments that are fastened together in a linear configuration, with each segment comprising a frame and three modular track positions: middle, lower, and upper. The end segments contain can raise and lower MDCs between tracks, and at least one end segment may have entry and exit cassette loadlocks, loading and unloading robots, and MDC cleaning processes. The system automates the cleaning of MDC disc carriers, reducing the downtime customarily suffered in prior art systems of this type. The process sources may be mounted in a number of ways on each universal module to optimize angle-of-incidence and distance parameters. Each process module contains a track segment that may rotate so that a further angle, or “tilt”, may be imposed for processing optimization.

The above and other objects and advantages of the present invention shall be made apparent from the accompanying figures and the description thereof.

### BRIEF DESCRIPTION OF THE DRAWINGS

The accompanying figures, which are incorporated in and constitute a part of this specification, illustrate embodiments of the invention and, together with a general description of the invention given above, and the detailed description of the embodiments given below, serve to explain the principles of the invention.

FIGS. 1 and 2 are schematic layout views of disk processing systems of the prior art.

FIG. 3 is a schematic view of one embodiment of a disk carrier of FIGS. 1 and 2.

FIGS. 4 and 5 are schematic perspective views of a disk carrier of the present invention.

FIG. 6 is a schematic of a cooling station.

FIGS. 7, 8, and 9 demonstrate a beam source and the angle of rotation.

FIG. 10 is a layout schematic including an Intersection Module.

FIG. 11 is a schematic microlevel view of embodiments of sequences for making a discreet track media.

FIG. 12 is a schematic view of a linear processing line for carrying out the first embodiment of FIG. 11.

FIG. 13 is a perspective view of a linear processing line.

FIG. 14 is data chart graphically illustrating measured selectivity.

FIGS. 15A-15I are sequential schematic cross sections of a discrete magnetic media being made with a hard mask process.

FIGS. 16A-16J are sequential schematic cross sections of a discrete magnetic media being made with a mask enhancement process.

FIG. 17 is a representation of a single trench cross-section.

FIG. 18 is data chart illustrating measured selectivity and angle dependence.

FIG. 18A is a cross section schematic of a scanning electron micrograph (SEM) illustrating gap-filling with ionized PVD.

FIG. 19 is a schematic cross-section of a three level linear processing system.

FIG. 20 is a schematic view of a box shaped linear processing system.

FIG. 21 is a perspective view with transparent faces of a Universal Process Module arranged in two module configuration without any process sources but showing the MDC assembly.

FIG. 22 is a summary of Dual Hard Mask Patterning options, similar to FIGS. 15A-15I.

FIG. 23 is data chart illustrating measured selectivity as labeled.

FIGS. 24 and 25 are charts with information regarding the Mask Enhancement process similar to FIGS. 16A-16J.

FIG. 26 is a collection of data charts for Inter-track or inter-bit isolation as labeled.

FIGS. 27, 28, and 29 illustrate aspects of the Universal Process Module (UPM) movement and the Multi Disc Carrier

FIG. 30 illustrates a process source for atomic layer deposition.

FIG. 31A,B,C are sequential schematic views as indicated in FIG. 15G.

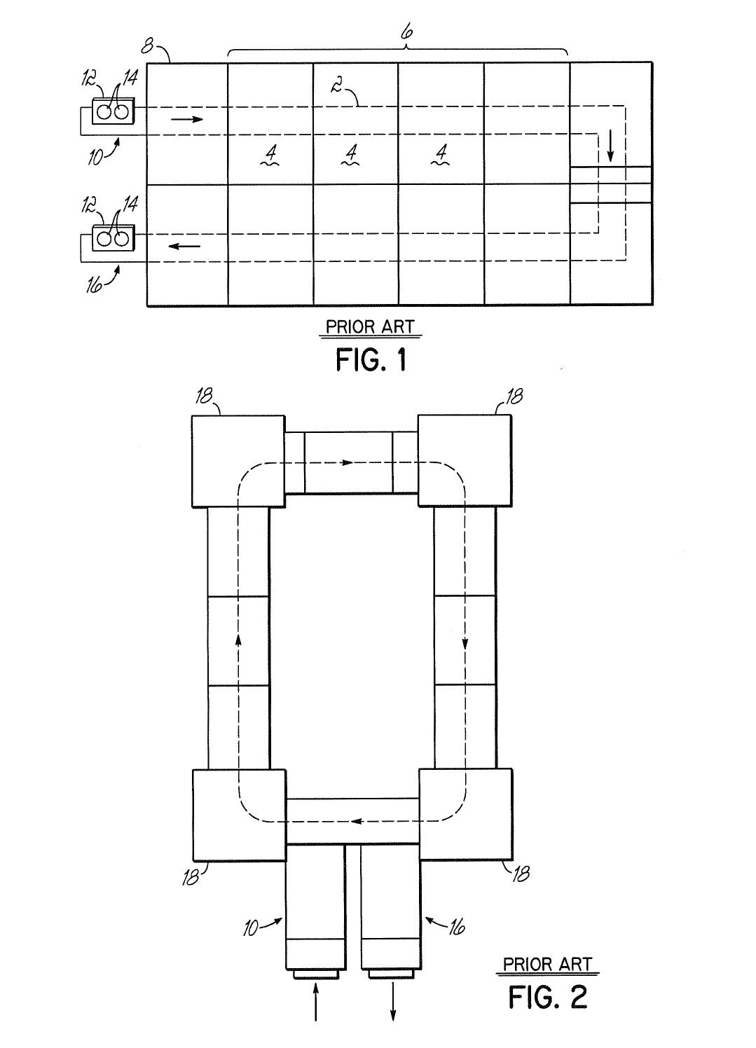

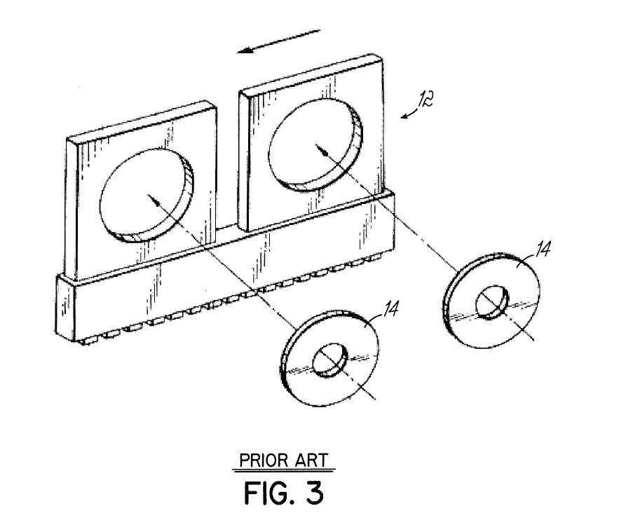

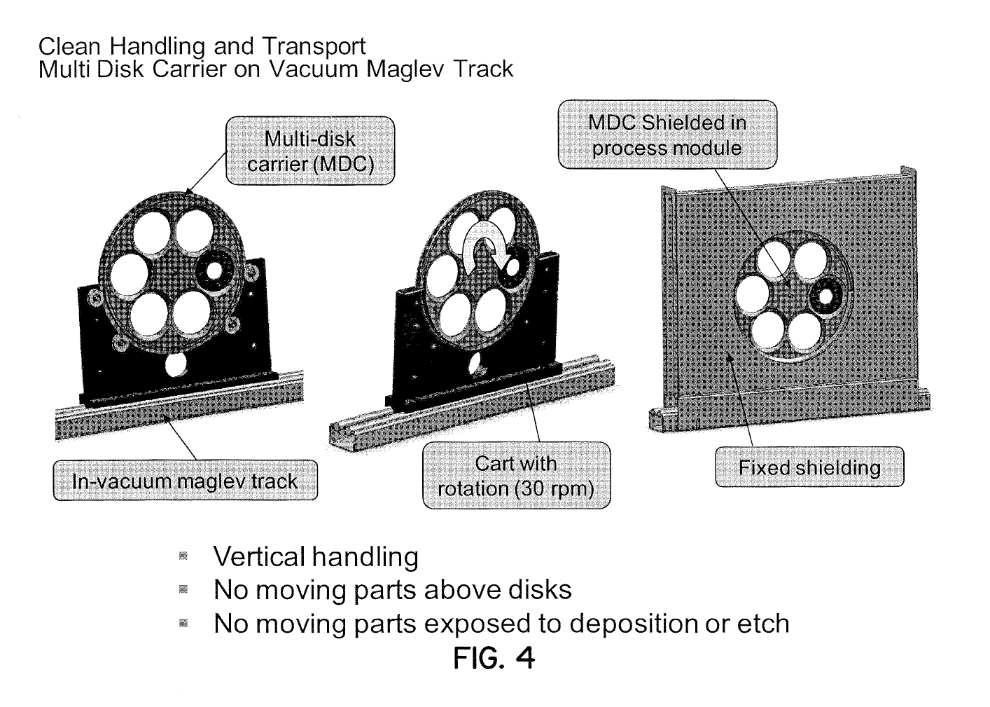

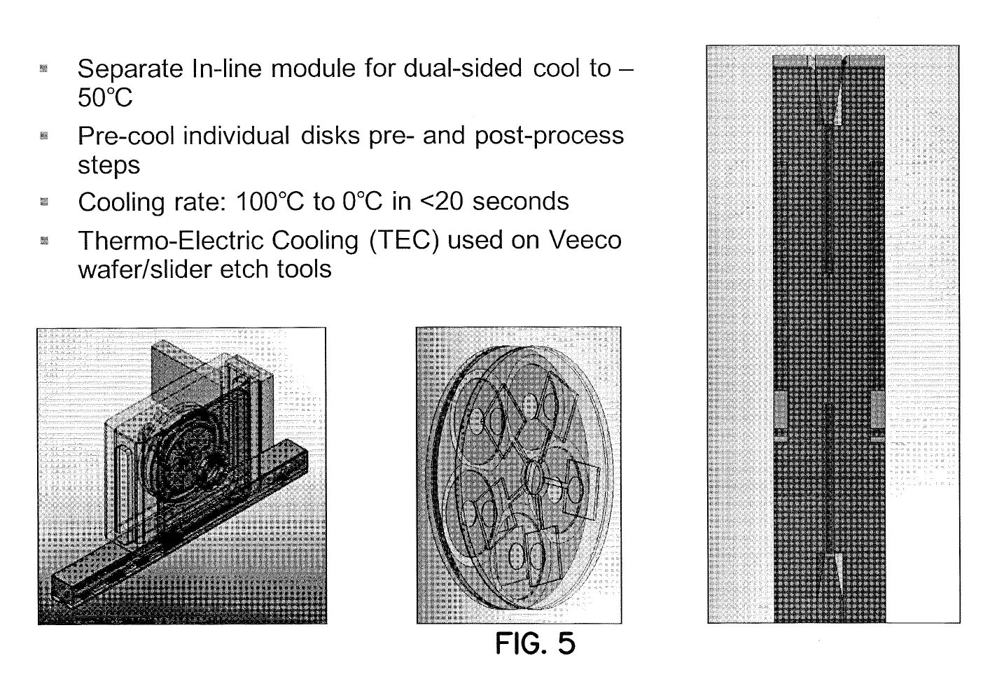

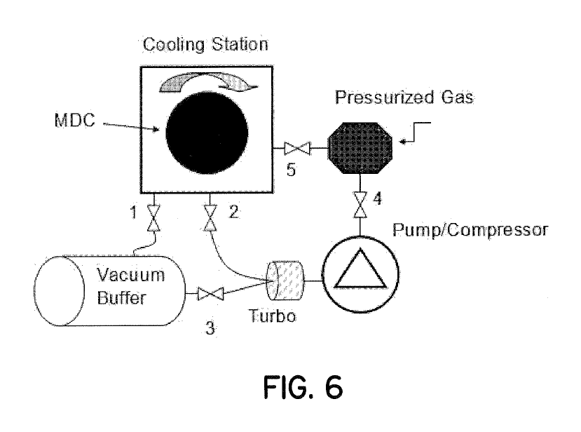

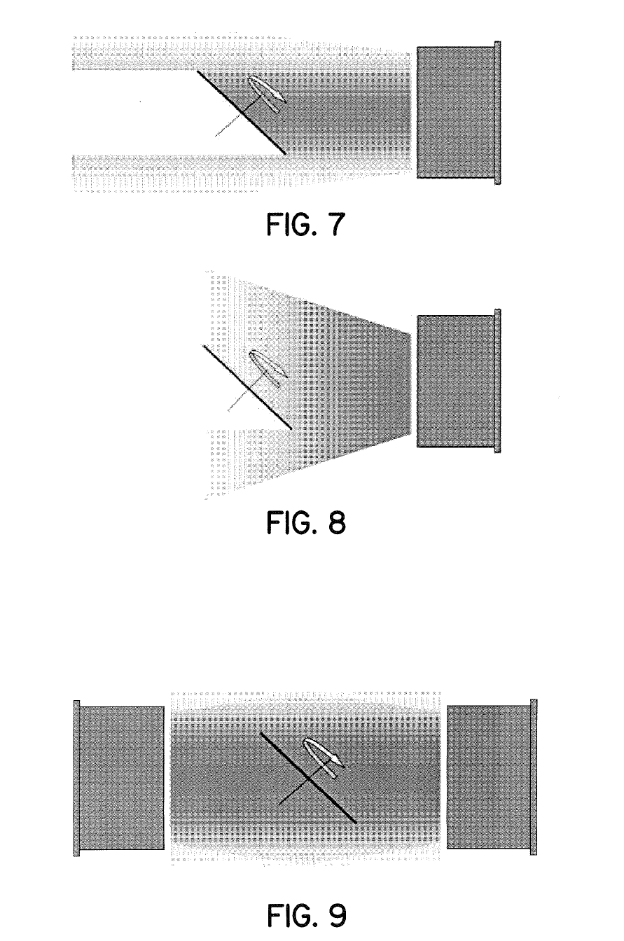

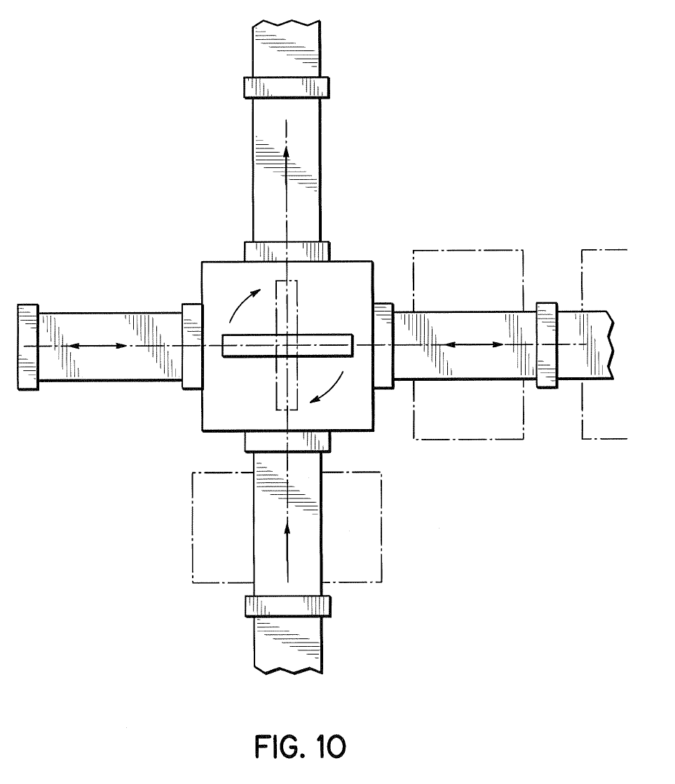

### DETAILED DESCRIPTION OF SPECIFIC EMBODIMENTS

### First Embodiment

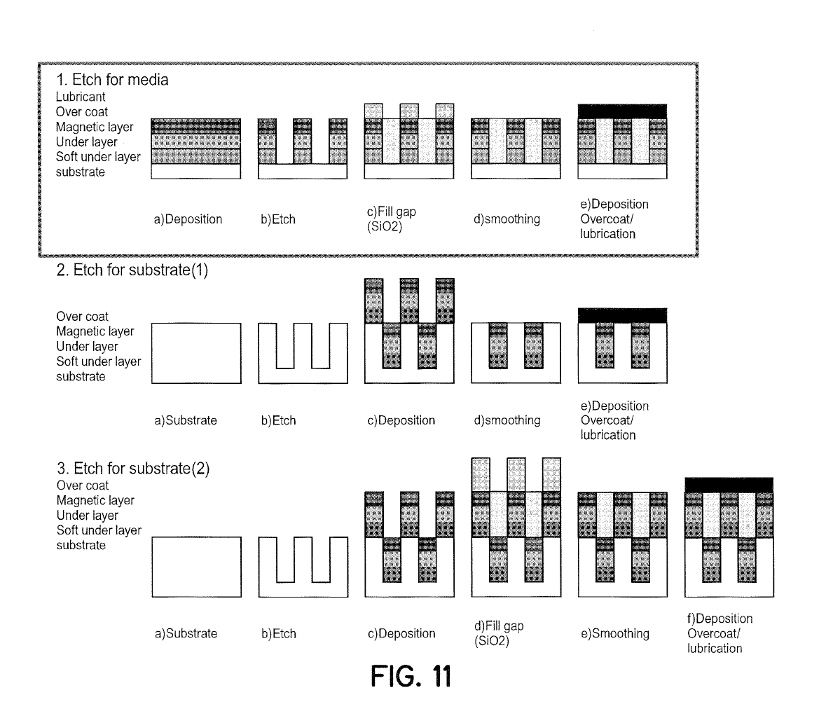

In one embodiment of the present invention, substrates such as magnetic memory storage discs, are processed in a vertical orientation on both sides simultaneously, through the process steps of pattern transfer, gap fill, planarization, and overcoat deposition, at a high rate through a linear system that requires relatively small floor space. This processing sequence is represented graphically in the outlined approach labeled “1. Etch for Media” of FIG. 11. FIG. 11 also has two other approaches. For all three, the labels along the left of the figure correspond to the graphically drawn layers.

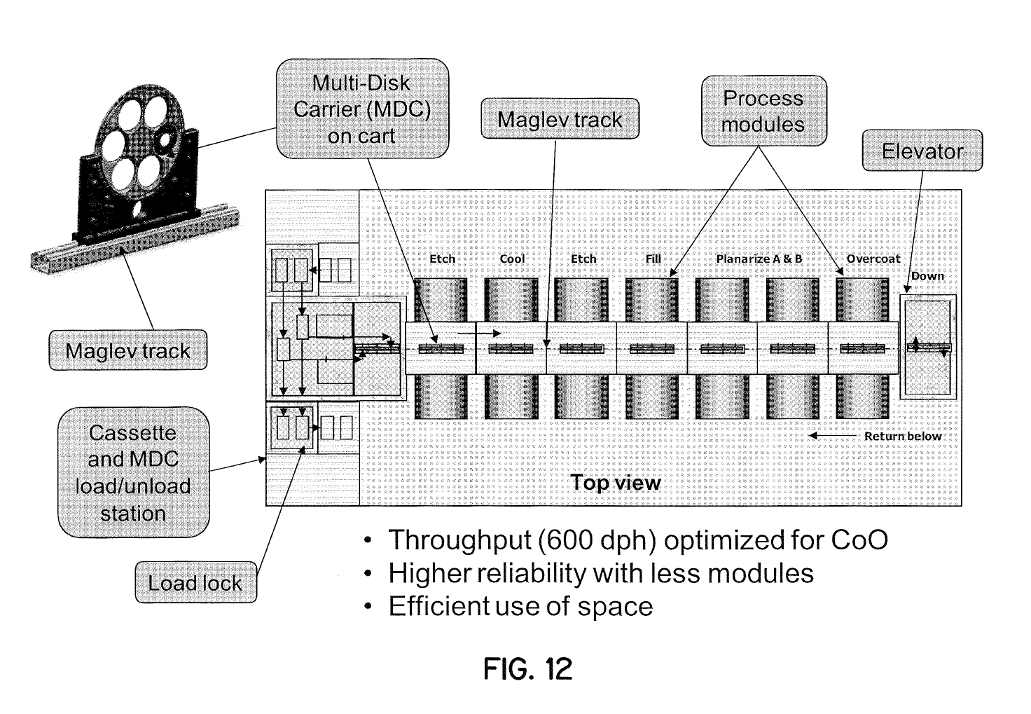

An embodiment of a linear processing system consistent with the “Etch for Media” process sequence , is represented in FIG. 12.

This embodiment has a linear configuration of eight process stations configured as Etch, Cool, Etch, Ash (as shown, it is within the second etch), Gap Fill, Planarization A, Planarization B, and Overcoat. Under each process station is one segment of a Transfer/Shuttle Shaft, and these are connected linearly to form a continuous return path for finished discs on MDCs and for empty MDCs being shuttled to and from the MDC Cleaning station.

The front end station (on the left) is configured for loading and unloading. It accepts cassettes of discs into a multi-cassette vacuum loadlock, loads discs from the cassettes onto MDCs under vacuum, elevates returning MDCs from the transfer/shuttle level, unloads finished discs from MDCs into cassettes, and passes the finished cassettes back to the production line through an exit vacuum loadlock.

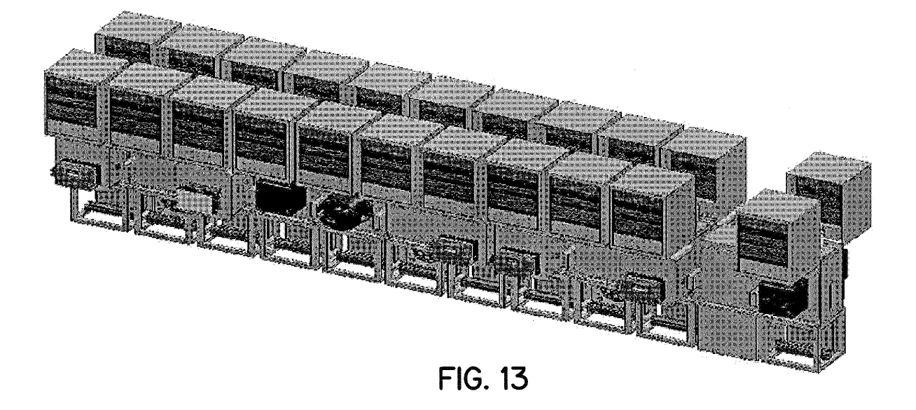

The rear end station (on the right) contains an MDC cart elevator, and has attached to its rear end an MDC Cleaning Station and accumulator, as shown in FIG. 13.

### Operation

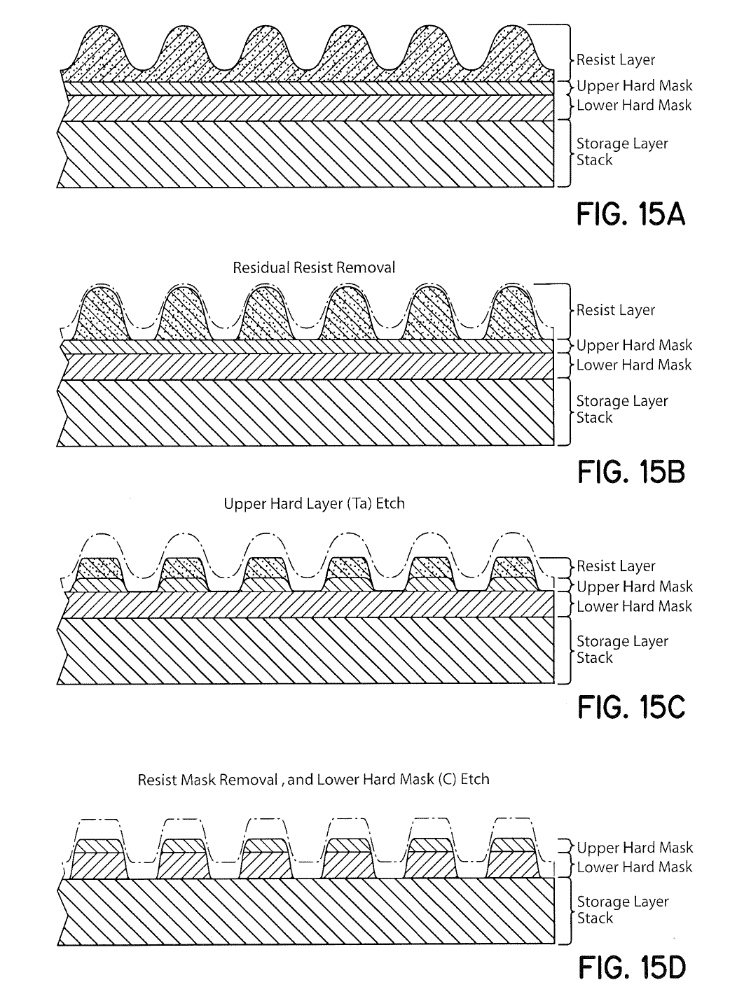

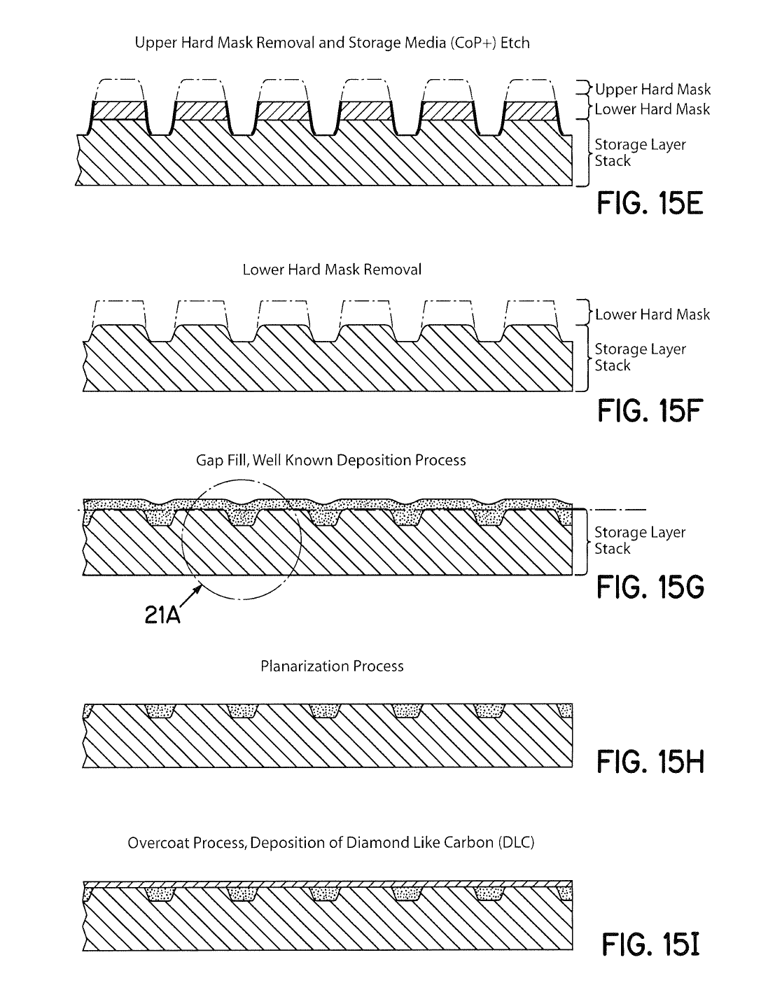

FIGS. 11 and 12 are supplemented by schematic enlargement FIGS. 15A-I, and 16A-J that have steps in common with FIGS. 11 and 12. FIGS. 15A-I, and 16A-J will be referenced below when helpful.

### Front End

In this embodiment of the present invention, cassettes full of discs ready to be processed are placed into an entry loadlock on the front end station. The front end station has an entry loadlock on one side, and an exit loadlock on the other. Those familiar with the art will be familiar with and comprehend the cassette loadlock and its operation.

The loaded discs (FIG. 15A) have already had masking material, for instance photoresist, applied to both sides of them. The masking material already has a pattern inscribed by conventional lithography techniques or by nano-imprint. The inner door valves of each loadlock then open to the MDC loading/unloading chamber, which is maintained at vacuum. The cassette is removed from the entry loadlock and positioned for the loading operation. Discs from the cassette are loaded onto empty MDCs by a vacuum robot. The empty cassette is loaded with processed discs by the unloading robot, and placed into the exit loadlock. If it is impractical to move the cassettes into vacuum, an atmospheric robot may transfer discs singly or in a batch from the cassette into the load-lock that contains one or more buffer cassettes or disk trays. After the load-lock has been pumped down, the vacuum robot would load the discs onto the MDCs. In this manner, the cleanliness of the load-lock is maintained.

### Etch 1

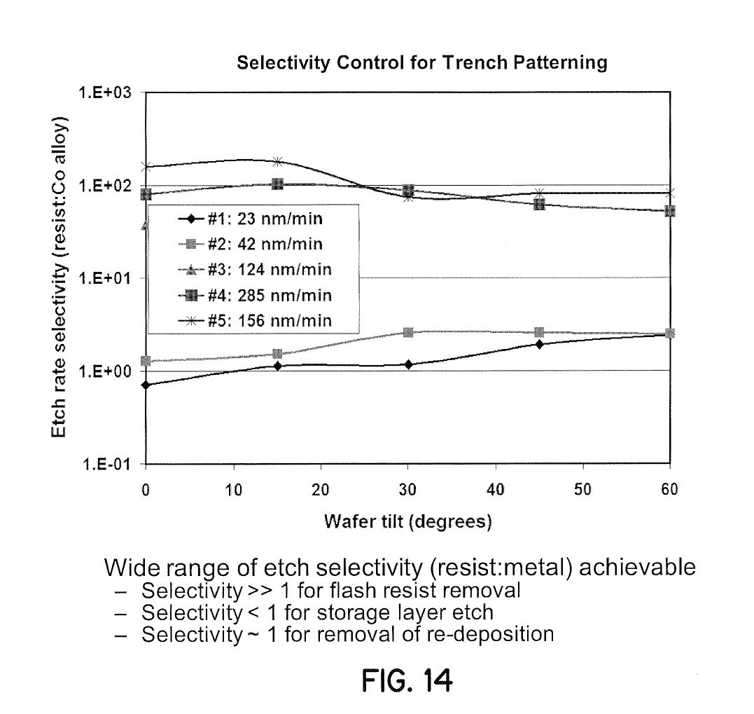

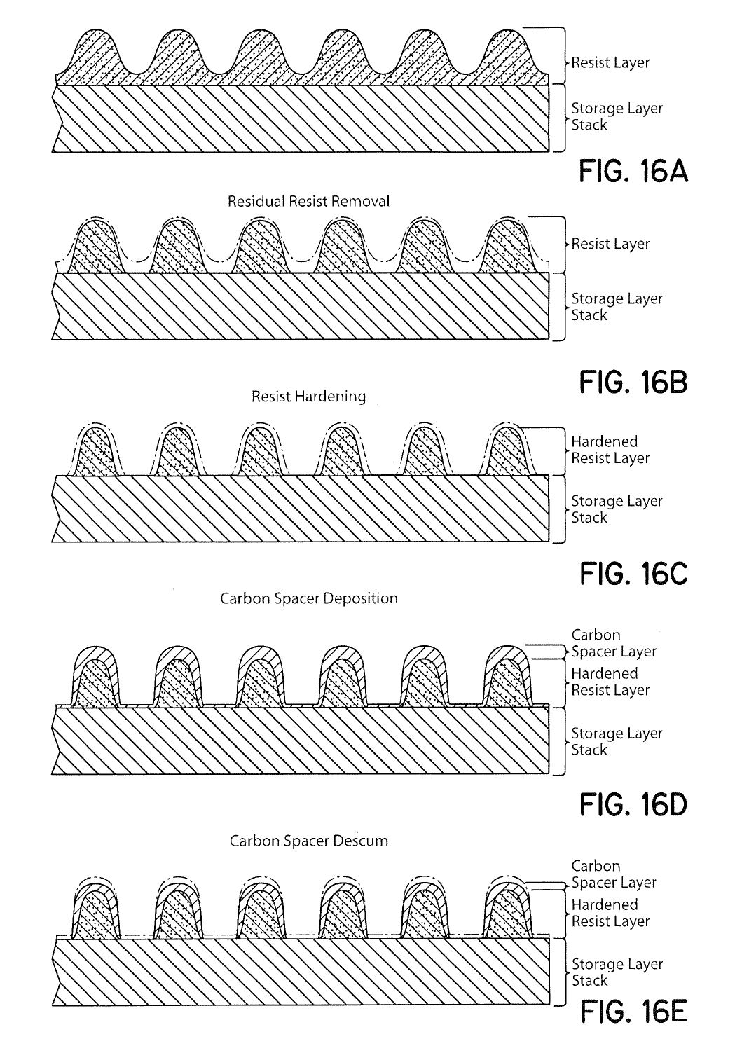

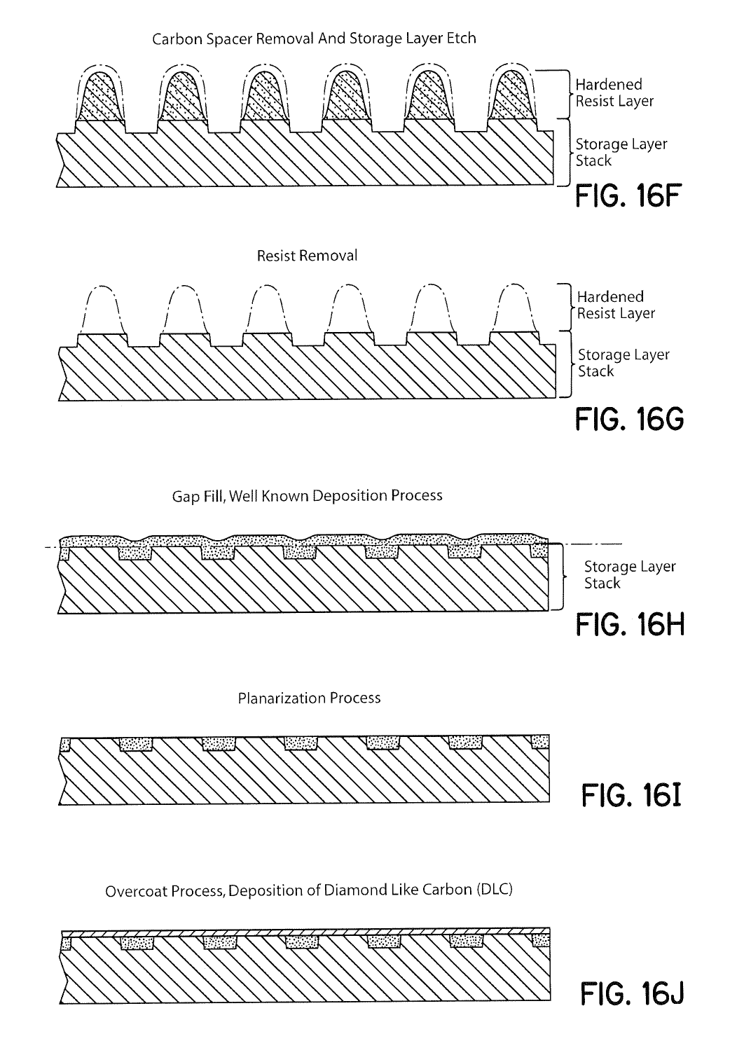

Upon being loaded with discs, each MDC rides its cart, magnetically driven from outside the chamber, through a gate valve into the first process module. The carts traverse segments of magnetic rail at the floor of each process module. In each process module, removable shields are positioned to protect the cart and edges of the MDC, minimizing the areas that will be directly exposed to processing. In the first process module, normal incidence low-energy (150 to 400 eV) ion beams containing argon and oxygen ions are used to remove any residual resist within the trench, also termed a “descum,” as well as thin the patterned masking layer (FIG. 15B). The duration of this step is adequate to completely remove the thin indented portions of the patterned masking layers, typically 10 to 30 nm, exposing the magnetic recording layer or hard mask beneath the pattern. The use of a mixture of argon and oxygen (RIBE) in this step results in an etch rate that is selectively tens of times higher for the masking layer, usually a photoresist compound, than for the magnetic layer being exposed by the process, as shown in FIG. 14. Since the normal incidence ion beam strikes a surface that has been indented with a pattern, the ions will not be striking everywhere at normal angles (90 degrees). For instance, they will strike the sidewalls of the pattern indents at grazing angles, and those familiar with the art know that if there is an angle-of-incidence dependence to the etch rate, faceting will occur. For many ion beam etch processes, the etch rate is actually a maximum at incidence angles of 45-60° which accentuates the formation of facets. Thus it is important to choose process conditions that minimize the angle of incidence dependence for this process step. A process condition in which the etch rate is the highest for normal incidence is the desirable for this process step. In one embodiment of the present invention, the use of an O₂:Ar ratio of 2:1 or greater and low beam energies (<250 V) results in high mask layer etch rate that is highest at normal angle-of-incidence and drops off as the substrate is tilted away from the beam. This results in excellent pattern transfer accuracy. As this step is completed, ion mass spectroscopy or optical emission detects the Co alloy constituents in the gas-phase exhausts, and this step automatically stops. Enough of the thicker portions of the masking layer material remain, protectively covering the areas intended to be recording tracks or discrete bits. Other oxygen containing gases such as N₂O, NO₂, NO, SO₂, CO₂, etc. may also be employed. Since polymeric materials are also etched by atomic fluorine, fluorine containing gases such as CF₄, CHF₃, NF₃, etc. may be used in combination with inert or oxygen containing gases. The inert gas (Ar) may be replaced by another inert gas such as Ne, Kr, Xe to tailor the angle dependence of the etch rate and shape the resist profile. This step may also be used to remove the hard mask layer (FIG. 15C) or the sidewall spacer (FIG. 16E), which is carbon. This step is normally performed at substrate tilts of 0-10° for best pattern transfer fidelity. Too large of a tilt while reducing faceting results in substantial increase in the trench width due to lateral etching and also induces the formation of a foot at the base of the masking layer.

At this point in the process, the ion sources adjust their argon-to-oxygen ratio to pure argon and their ion energy to 150 to 700 eV so that the magnetic layers, now exposed in the pattern, may be etched with good selectivity to the remaining masking layer (FIG. 15D). Other inert gases such as Ne, Kr or Xe may also be used to modify the selectivity. Reactive gases such as NH₃, CO, CO₂, C₂H₄, etc. may be used to increase the selectivity or reduce the angle dependence of the etch rate. Lower energies reduce the extent of faceting with a concomitant loss of etching rate. At very low energies, the beam may lose its collimation and become sensitive to the beam neutralization conditions. In an extreme case at very low beam energies, faceting may be replaced by undercut as the beam is deflected by charges that build up on the surface of the mask. Once again for this step, substrate tilts in the range of 0-10° are desirable to maintain the verticality of the sidewall. This step results in the removal of substantial amounts of magnetic material between the tracks or discrete bits, and thus the pattern begins to be transferred to the magnetic layer (FIG. 15E and 16F). This step also heats the discs significantly, so it is only partially completed in this module, to avoid overheating the masking layer. With the pattern now partially etched into the recording layer, the rotating spindle de-couples from the MDC, the chamber gate valves open, and the MDC moves to the second process module as the next MDC takes its place in the first process module. The storage layer etch may be preceded by a mask hardening process (FIG. 16B) in which the resist is exposed to moderate beam energies (400 V-700 V) for a short times (3-10 s) at a substrate tilt of 0-30 degrees to harden the resist which enhances the etch resistance of the resist mask during the subsequent etch of the hard mask or the storage layer.

In the second process module, the discs are cooled. In this module, the rotating spindle indexes the MDC into a stationary position aligned with a set of complimentary thermoelectric chucks that can cool the discs from 100 C to 0 C in about 20 seconds, and are capable of lowering the disc temperature to −50 C. The thermoelectric chucks may also incorporate gas flow to more effectively transfer heat away from the discs, improving the uniformity and the speed of the cooling process. Once the operator-selected temperature is reached, the gas flow is shut off, the cooling chuck array de-couples from the discs, the rotating spindle de-couples from the MDC, the chamber is returned to a programmed setpoint vacuum pressure, the gate valves open, and the MDC moves to the third process module as the next MDC takes its place in the second process module.

The alternative cooling method is to blow a mist of a volatile liquid or CO2 snow onto the hot disk surface for rapid cooling. For each disk, approximately 0.5-1 liter (gas phase equivalent volume at atmospheric pressure) of fluid is required to cool the disks in under 20 s. A rough pump connected to the chamber continually evacuates the chamber during the dosing of the disk with the cooling fluid, while a turbomolecular pump removes the remnant gases following dosing for rapid pump-down of the chamber to high vacuum before the MDC is moved to the next chamber.

### Etch 2

In the third process module, similar ion beam sources as in the first process module are used again to remove the remainder of the magnetic material between the tracks or discrete bits, and thus the pattern is now completely transferred to the magnetic layer. This could be a timed process, or an end-point monitor such as the optical end-point monitor from Verity Instruments or the SIMS end-point monitor from Hiden could be used to stop the etch when the storage layer has been removed in its entirety and the underlying seed layer is exposed. Since ion beam etching is very repeatable, end-point monitoring may be used periodically to establish the etch rate, and this newly determined etch rate may be used to define the etch time for subsequent MDCs.

The removal of residual masking layers and the etching of the pattern into the magnetic recording layer generally results in some re-deposition (FIG. 15E for example) of metals onto the remaining masking layers. An Ar/O₂ mixture with 5-20% O₂ is optimally suited, when applied at an angle of 10 to 40° from normal, to remove this material, so the MDC is now pivoted on its track section to form an angle between the ion sources and the discs of 20 to 40° off normal. The ion beam, with energy between 150 and 700 eV and the prescribed Ar/O₂ content, removes the re-deposition from the patterns. The tilt angle is chosen so that the beam reaches all surfaces of the pattern (i.e. sidewall and bottom) so that there is net removal rate from all surfaces. Depending on the sidewall angle of the mask, the aspect ratio of the trench pattern, and the substrate tilt used during the storage layer etch, a separate re-deposition removal may not be necessary.

The masking layer has typically formed a carbonized “skin” as a result of heating and ion bombardment, and this is removed at yet another optimized O₂/Ar ratio of 2:1 or greater, applied at an angle of 20°, and a beam energy of 150-400 eV. These steps are performed so that a substantial portion of the masking layers are removed without etching the sidewall of the magnetic layer. In order to minimize the etching of the sidewall, a larger tilt angle of 50-70° may be employed to remove the majority of the mask before moving to a smaller angle (0-20°) to remove the remainder of the mask.

The ion beam may be used to remove all of the masking layers including a hard mask, or a separate process module equipped with remote plasma sources that can activate gases suitable for “ashing” the remaining masking layers that have now been cleared of redeposited material and their carbonized skin The remote plasma sources uses gas mixtures that typically include an inert gas such as Ar or N₂ in combination with one of more reactive gases such as O₂, N₂O, H₂, or NF₃ dispersed uniformly over the discs. The ashing may be combined with an optional low energy RIBE process using an Ar/O₂ ratio of 5-20% O₂ at substrate tilt of 0-20°, to finish cleaning any mask layer residue before transfer to gap-fill process module.

### Gap Fill

In the fourth process module, a gap fill layer is deposited over the patterned magnetic film (FIGS. 15G or 16H). This layer may be of aluminum oxide, silicon, silicon dioxide, silicon nitride, α-carbon, CN, or similar suitable materials that may be deposited using well-known deposition techniques such as ALD, CVD, PVD, ionized PVD, HDP-CVD, etc. One of the criteria for choosing this layer is its ability to completely fill the trenches between the tracks with a dense material that does not outgas and is compatible with the DLC overcoat. Ideally the surface post gap-fill should be planar to reduce the need for planarization. Another criteria is its amenability to removal from the MDCs using a cleaning technology available to the MDC Cleaning stations.

Wet processing steps such as spin coating, planar imprint or electro-deposition may be used as well. Planar imprint is an extension of nano-imprint lithography where a flat, unpatterned template rather than a patterned template is used to achieve filling of small structures in the media while leaving a near planar surface following gap-filling. Integration of such processes into a vacuum processing tool is problematic. However variants of these wet processing steps such as condensed phase processing which are dry-like processes and can be performed at sub-atmospheric pressure are amenable to integration into the tool architecture described here.

After gap fill deposition, the resulting layer is non-planar, due to the coating of both the tracks or bits and the etched pattern around them. The lack of planarity could be especially severe in the servo regions that have wider features compared to the data track regions on the disk. The layer is made thick enough so that, in subsequent steps, the gap filling material that covers the tracks or bits may be substantially removed without leaving the material filling the gaps overly recessed. After gap filling, transfer steps described above are repeated, and the MDC moves to the fifth process module as the next MDC takes its place.

### Planarization A and B

In the fifth, planarization process (FIGS. 15H or 16I) module, several options may be used to planarize the gap fill layer. In one embodiment of the present invention, ion beams are used to smooth and planarize the surface of the gap fill layer. This step brings the magnetic tracks or bits close enough to the surface to be written to and read from accurately, but it is not desirable to etch the magnetic recording layer at the tops of the tracks or discrete bits to any significant extent, so an “end point” detection method is used, such as optical end-point or SIMS is necessary.

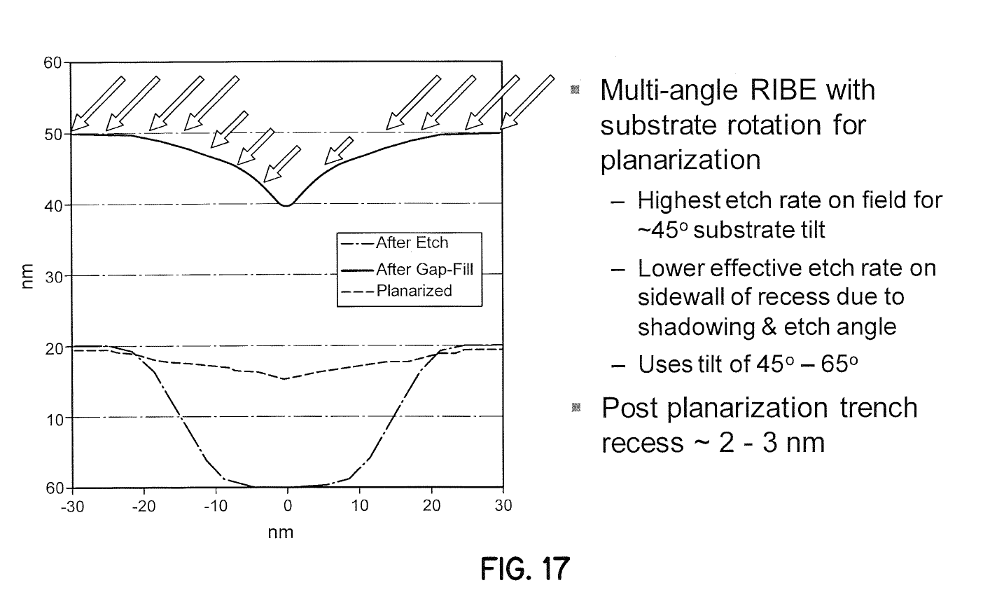

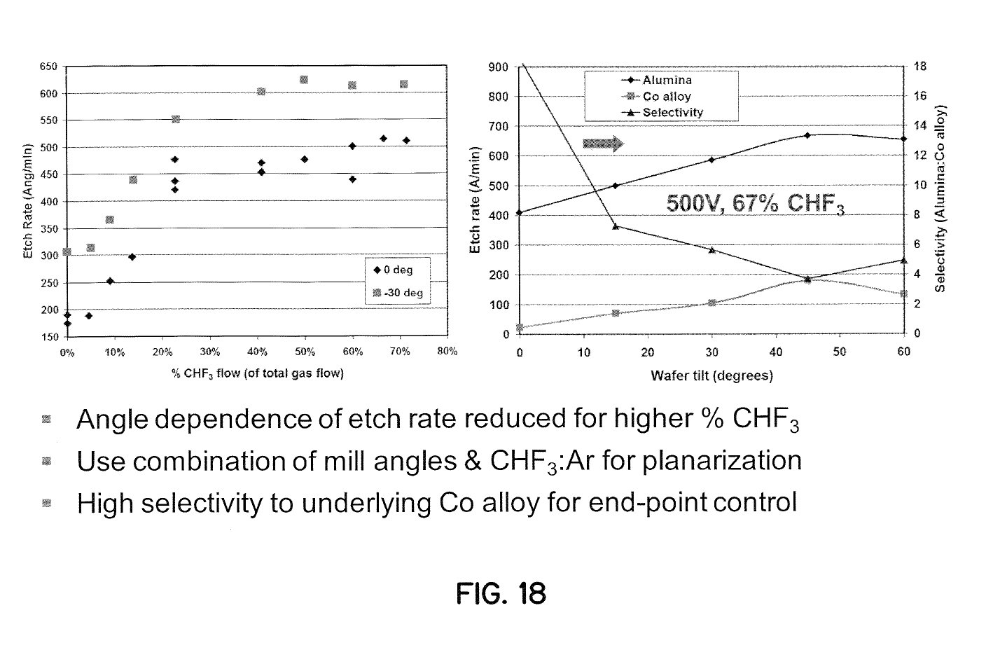

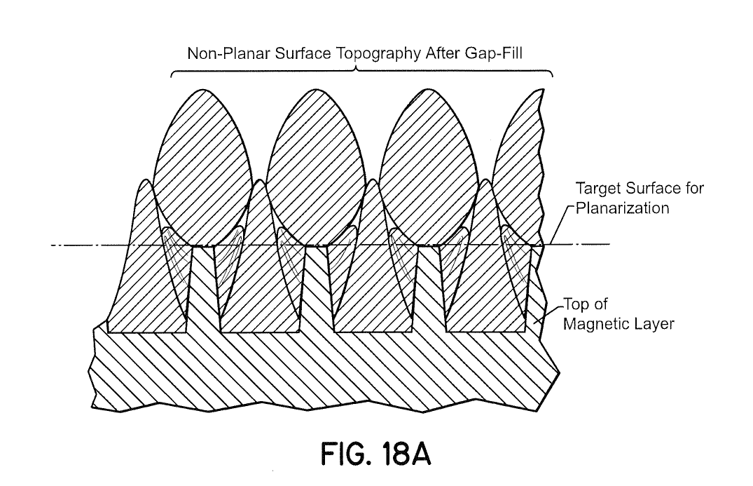

To selectively etch the high points at a high rate and the depressions at a significantly lower rate, the angle of beam incidence is steep: 45 to 65 degrees from normal incidence, as indicated in FIG. 17. To accommodate optimization of this angle, the large format ion mills are mounted with fixed tilt, and the cart and MDC assemblies are rotated to a programmable additional angle, as was done in the third process module. In the case of a PVD deposited Al₂O₃ or SiO₂ gap filling layer, a mixture of argon and CHF₃ gas is used to increase the etch rate, the angle-of-incidence sensitivity and the selectivity, as illustrated in FIG. 18. For Si based gap-fill, a mixture of CF₄, O₂ and Ar is appropriate, while for a carbon based gap-fill a mixture of Ar and an O₂ containing gas is appropriate. The final surface finish of the surface post-planarization must be less than 5 A. This is accomplished by using multi-step processes that incorporate high energy, low selectivity etch steps that preferentially remove surface roughness that may develop during the planarizing process. A sixth process module may be equipped identically, and the process of planarization continued at a slower rate to promote smoothing and to make endpoint detection more accurate.

The recess depth in the cavities between the tracks or bits should be less than 5 nm and preferably less than 2 nm post planarization. If an adequate level of planarization is not achieved, the sequence of gap-fill and planarization is repeated until the desired planarity is achieved. Increasing the number of gap-fill and planarization cycles is time consuming and expensive and thus the gap-fill and planarization methods that require the least number of cycles (ideally one cycle) are preferred.

### Overcoat

A following process module uses ion beam (e.g. direct deposition, filtered cathodic arc, etc.), PVD or CVD technology (e.g. PE-CVD, hot-wire CVD, etc.) to apply a thin overcoat layer (FIG. 15I or 16J) to the discs, typically 2-3 nm of diamond-like carbon, or DLC. The DLC layer serves to protect the magnetic material in collisions with the read and write heads, and to bond with the final lubricant layer. This is typically a bilayer consisting of a hard, dense, pin-hole free a-C;H layer adjacent to the magnetic material and an outer layer of a-CNₓ that is electrically conductive and is compatible with the lube.

After the overcoat is applied to the discs in the MDC, it enters the end station of this embodiment of present invention, where the track section is mounted on an elevator. This end station takes the MDC and its cart from the process module level down to the return track that runs below the length of the system through a series of connected chambers that form a continuous vacuum transfer chamber from the back end to the front end of the system.

When the MDC reaches the front end station, it is received by another cart elevator, and raised to the load/unload station, where a vacuum robot unloads the processed discs into their cassettes, and places the processed cassette loads into the exit loadlock. The exit loadlock door closes, the loadlock vents up from vacuum to atmospheric pressure, and the cassette is unloaded from the system by an operator.

It is known to those familiar with the art, that any substrate carriers that are repeatedly cycled through systems with deposition and/or removal process exposure will accumulate depositions and/or residues that will eventually impair the use of the carrier. It is also generally known, that the impairment caused by this buildup is accelerated by periodic exposure to the ambient factory atmosphere, where moisture absorption and oxidation may proceed quickly, degrading adhesion between layers and causing increased internal stresses within them. Gases trapped in micro-cavities within the film when the MDC is exposed to atmospheric may cause the deposited film to pop-off when the MDC is subsequently pumped down. These problems are delayed by avoiding such periodic exposure. As described above, the MDCs cycle through re-use without exposure to the factory atmosphere. Within the tool, periodic automated MDC cleaning extends the useful life of these carriers between times when they have to be serviced and possibly refitted outside the system.

### First Additional Embodiment

In another embodiment, the process sequence described above is applicable to the approach represented graphically in the outlined approach labeled “1. Etch for Media” in FIG. 11. However, there are several alternative processing sequences in which the steps of etching, deposition and planarization are in a slightly different order, for example those if the lower areas of FIG. 11. Except for the number and sequence of processes, the operation of these embodiments proceeds in essentially the same way as the operation of the preferred embodiment, described above.

### Second Additional Embodiment

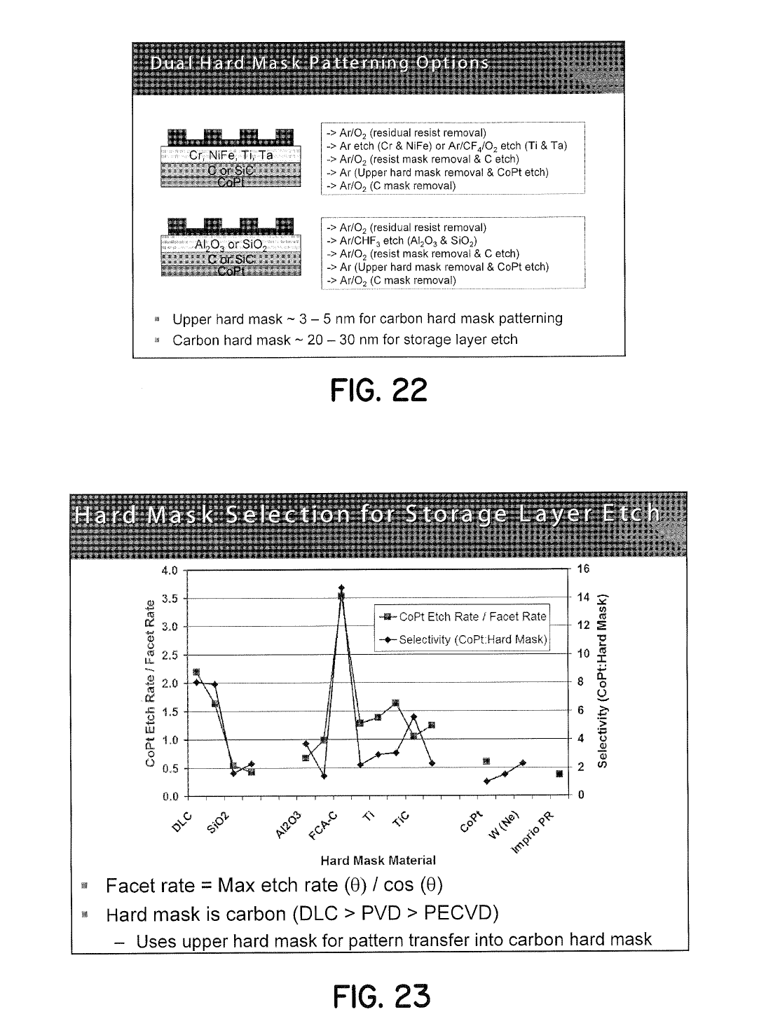

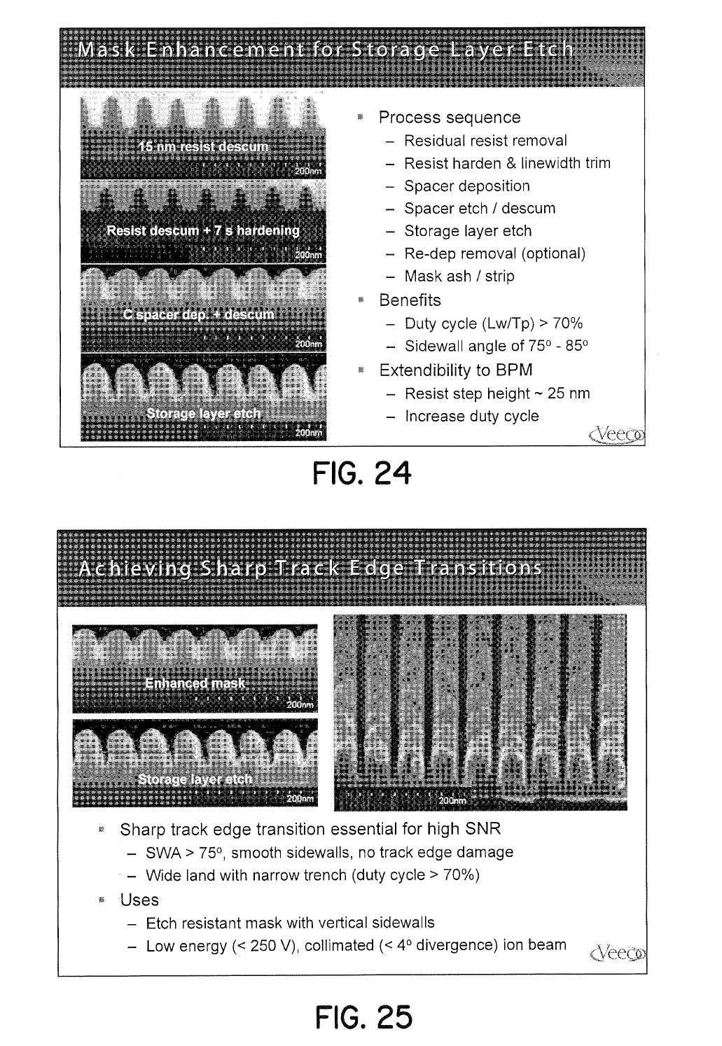

In another embodiment a hard mask may be used to pattern the storage layer since the imprint mask may not have sufficient etch resistance to survive during the storage layer etch. A hard mask strategy involving bi-layer hard masks is illustrated in FIGS. 15A-15I. The captions in those figures mention certain chemical elements and compounds that are used, but those, and any mentioned in this description are examples, and are not limiting. The disk is loaded with a lower hard mask and upper hard mask already under the imprinted photoresist. The top hard mask layer should be chosen such that it can be etched readily without eroding too much of the resist while remaining relatively intact during the etch of the bottom hard mask layer, while the bottom hard mask layer should have sufficient etch resistance to survive the storage layer etch. Among choices for the upper hard mask are Cr, NiFe that may be etched using Ar, or Ti or Ta that may be etched by using Ar/CF₄/O₂ , or Al₂O₃ or SiO₂ that may be etched by Ar/CHF₃ . Typical thicknesses are 3-5 nm Keeping the bottom sidewall of the hard mask near vertical throughout the entire storage layer etch may provide that near vertical sidewalls during the storage layer etch. This means that the thickness of the hard mask layer and its etch resistance must be such that the facet that is inevitably formed on the top corner of the hard mask does not reach the bottom corner of the hard mask at the end of the storage layer etch. Typically a form of carbon, typically 20-30 nm thick, is best suited for the bottom hard mask layer since it is easily patterned via an Ar/O₂ etch using RIBE or ICP RIE, which simultaneously removes the imprinted resist. Some forms of carbon such as filtered cathodic arc carbon (diamond like carbon) and PVD carbon have good etch resistance and are suitable hard mask layers as shown in FIG. 22.

### Third Additional Embodiment

In another embodiment, shown in FIGS. 16A-16J, instead of using a hard mask, a mask enhancement process can be used to achieve sharp track transitions. Sharp track transitions are essential for high signal to noise ratio (SNR). These require storage layer trench side wall angles (SWA)>75°, smooth storage layer sidewalls, no track edge damage, and wide land with narrow trench (duty cycle>70%) after storage layer etch and mask removal. In order to meet these needs, an etch resistant mask with vertical sidewalls and ion beam etching using a low energy (<250 V), collimated (<4° divergence) ion beam is utilized.

An example of a mask enhancement process is described in FIGS. 16A-16J. The captions in those figures mention certain chemical elements and compounds that are used, but those, and any mentioned in this description are examples, and are not limiting. Broadly it includes: formation of a resist layer (FIG. 16A), residual resist removal (FIG. 16B), resist hardening & linewidth trimming (FIG. 16C), carbon spacer layer deposition (FIG. 16D), spacer etch/descum (FIG. 16E), storage layer etch (FIG. 16F), re-dep removal (optional), and mask ash/strip (FIG. 16G). The processes described above can be used to implement each of these steps, and the specific conditions and processing approach is somewhat pattern dependent. The spacer deposition module would have the same essential hardware as the Gap Fill module. The spacer can be deposited either before the residual layer of the resist is removed or following residual resist removal. utilized.

Numerous variants variants of this sequence are possible and spacer materials other than carbon may be used. The mask enhancement process may be used in conjunction with an imprint mask or a hard mask, although it is primarily intended to replace the hard mask process. By using the enhanced mask process, patterning of sub 20 nm wide features with near vertical sidewalls and low sidewall roughness is possible, demonstrating a clear extendibility to BPM. By way of example, at the time of resist hardening in FIG. 16C, it shrinks in all directions by approximately 10%. In FIG. 16D, the carbon spacer thickness is typically 10 nm compared to 30 nm trench width. The carbon spacer is not conformal. Thickness on top is approximately 10 nm, on top corner approximately 8 nm and bottom approximately 2 nm. After carbon spacer deposition, the sidewall appears more vertical than previously. In FIG. 16F, all the carbon is removed at the bottom of the trench with a 100% over-etch (effective 4 nm removal) which reduces the carbon thickness on the top by 4 nm and along the sidewall by approximately 1 nm (etch rate on sidewall is lower since it is near vertical).

### Fourth Additional Embodiment

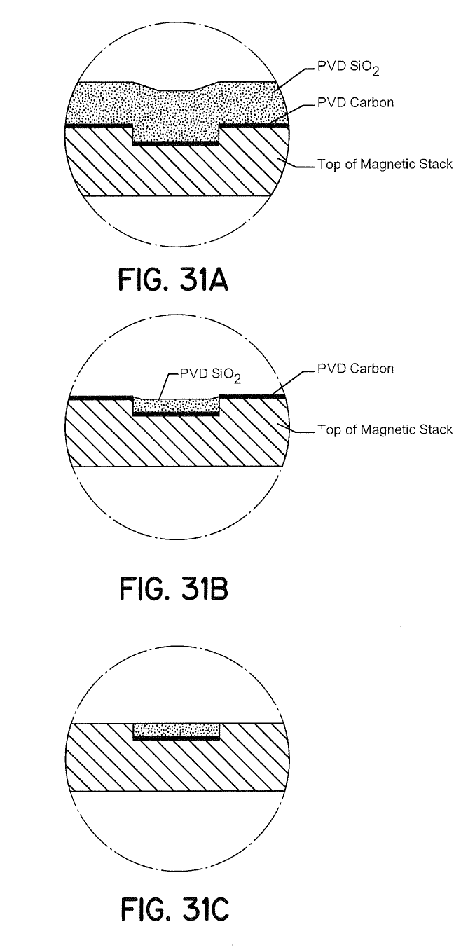

In another embodiment shown in FIGS. 31B-C, the gap-fill material is a bilayer (for example, 5 nm carbon followed by 45 nm SiO2). FIG. 31A shows the trench in the magnetic stack that has been filled by a bilayer of PVD carbon (approximately 5 nm thick, black line) and PVD SiO₂ (approximately 50 nm thick layer above black line). During the planarization etch, the 45 nm SiO₂ is removed which typically results in the SiO2 being 5 nm recessed below the surrounding carbon layer as seen in FIG. 31B, but nearly even with the magnetic layer. Then the exposed carbon on top of the magnetic layer is removed as seen in FIG. 31C, with high selectivity to the SiO2 and the magnetic layer. After the process the effective recess depth is reduced to almost zero. This method achieves a controllable recess depth. The thickness of the PVD carbon is selected such that after the carbon removal, the surface is almost planar with a trench recess depth of <5 nm In the structure shown, the trench depth is approximately 20 nm and the trench width is approximately 100 nm to reflect the type of pattern that typically occurs in the servo region of the disk.

### Fifth Additional Embodiment

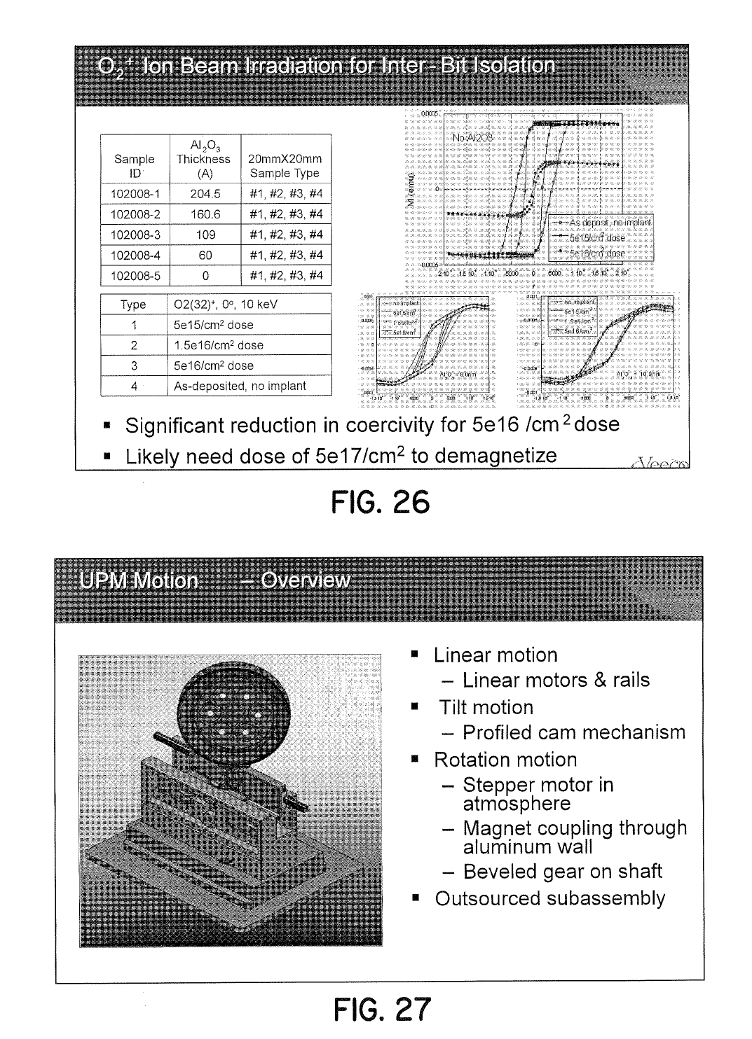

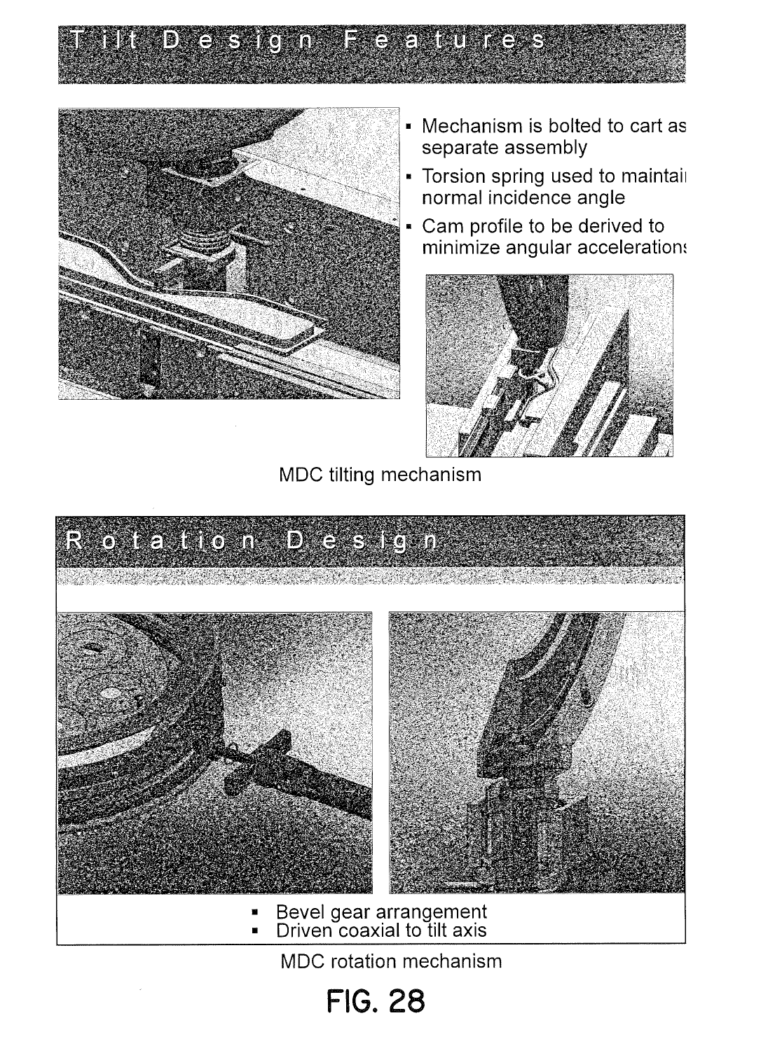

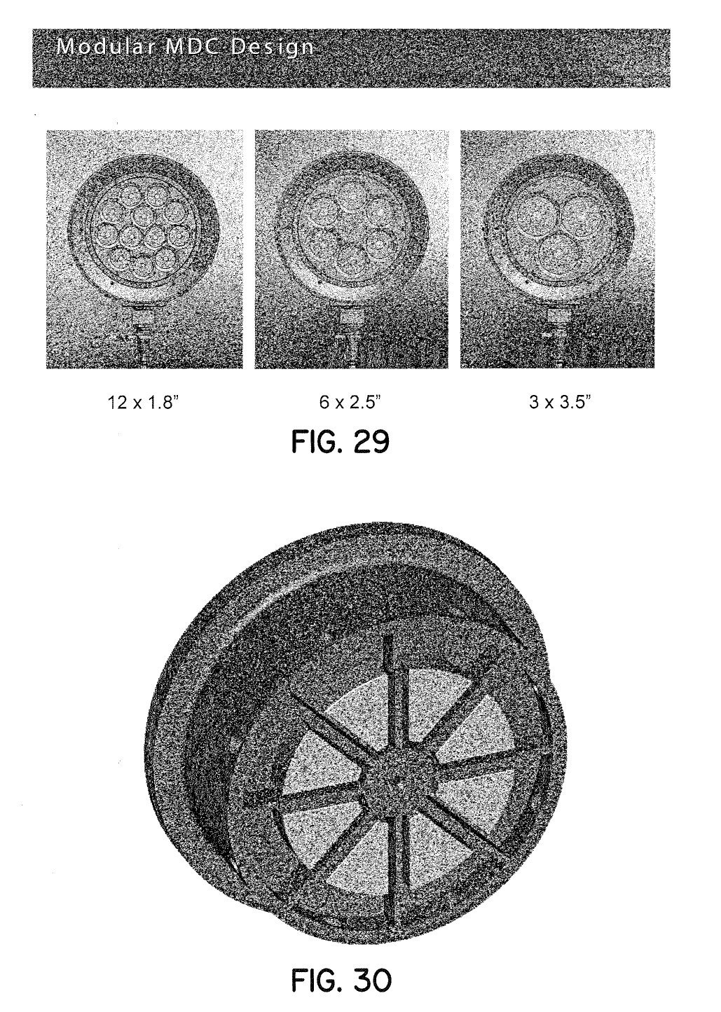

In yet another embodiment, ion implantation may be used to disrupt the magnetic properties of the magnetic layer, thus creating a “magnetic trench” rather than a physical one, and the universal module accepts the hardware necessary to accomplish this. Instead of physically isolating the tracks through removal of the storage layer between the tracks the regions between adjacent tracks or bits may be demagnetized. This may be done for example by implanting O₂⁺ or other species to demagnetize the material. FIG. 26 demonstrates that it is possible to demagnetize the storage layer by implanting it with O₂⁺ at energies of 10-20 keV provided the dose is sufficiently high. A dose in excess of 10¹⁷/cm² is likely needed to completely demagnetize the material. This dose and energy is achievable either through plasma immersion ion implantation or by extracting a high current O₂⁺ beam from an ion source and biasing the grids or the disks to achieve the desired implant energy. One of the concerns with implantation is the lateral straggle and thus dual energy or dual ion implants in conjunction with focused flash annealing (e.g. via laser or flash UV) will be necessary to limit the lateral straggle.

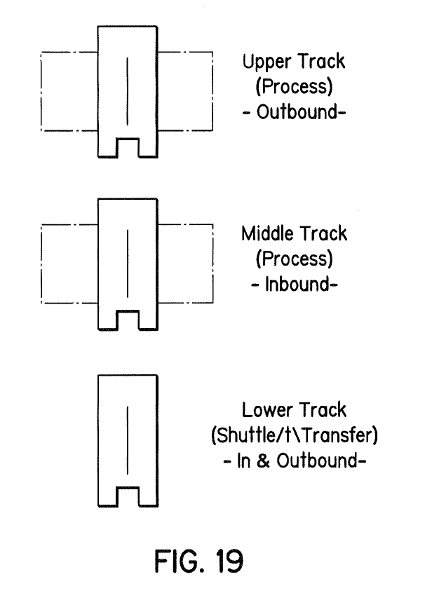

In the embodiments described above, processing proceeded from the front to the back of the system, and returned along the lower transfer/shuttle shaft. In each case, the embodiments could be shortened by making use of the optional upper track/process line positions. MDCs would proceed from front to back along the Middle or Upper track, completing a portion of their processing, then be elevated or lowered to the other processing track, where their processing would continue as they moved back toward the load/unload station. This would free up the lower transfer/shuttle shaft for use in getting MDCs to and from the MDC cleaning station and any accumulators. A schematic cross section of such an arrangement is shown in FIG. 19.

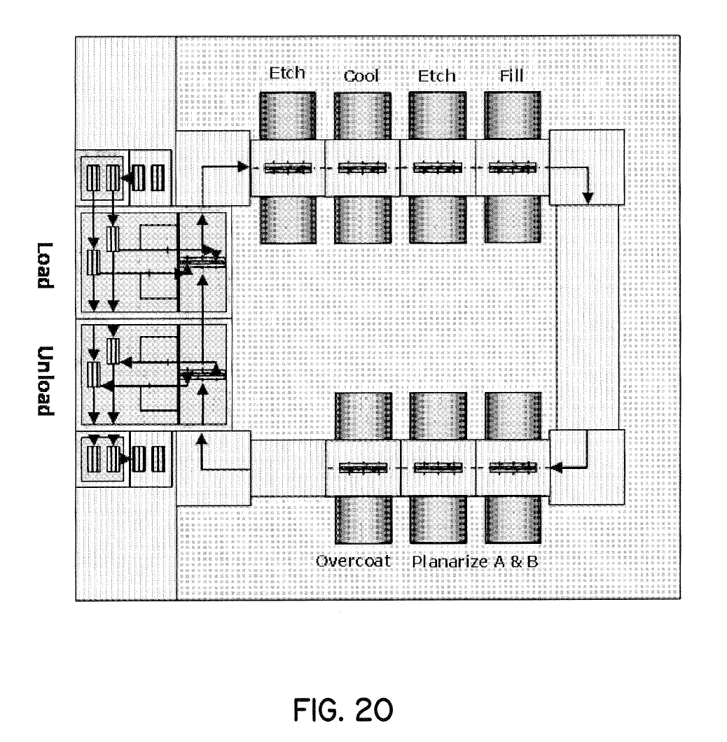

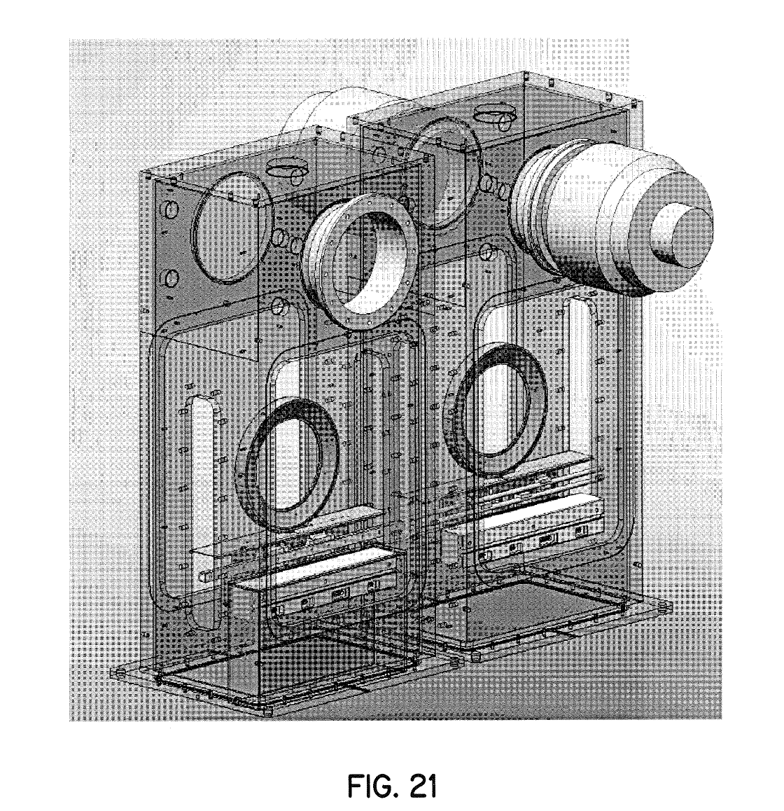

In yet another configuration of the embodiments of the present invention, intersection modules are used to bring the system into a “box” configuration, as shown in FIG. 20. In this case, “bridging” chambers made up of transfer/shuttle shaft segments bring the MDCs across to the return inline processing path.

Although only a limited variety and quantity of process sequences have been discussed, the present invention is highly suited to perform virtually any advanced process envisioned for future pattern transfer. These advances will certainly be required as the sizes of tracks and discrete bits are further reduced. For instance, the mask enhancement process may be beneficial at sub-100 nm spacing to preserve critical trench and inter-bit pattern dimensions. Although ion beam etching has been used to illustrate most of the etching steps, other forms of etching such as reactive ion etching, high density plasma etching, remote plasma etching, atomic layer etching, vapor etching, and/or wet chemical etching may be substituted as appropriate. Similarly for deposition steps, a variety of deposition technologies may be suitable.

Importantly, the present invention enables uniform and symmetrical bombardment of multiple discs using a wide range of angles-of incidence. The use of large format ion beams onto multi-disc carriers greatly enhances the number of discs processed per minute and per unit floor area. By introducing three levels of transfer, and using one of them as a shuttle shaft, the present invention makes the use of integral disc carrier cleaning possible, alleviating a burdensome and costly overhead issue.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. Apparatus for processing of a plurality of substrates, comprising
a multi disc carrier comprising a rotatable dial carrier holding a plurality of said substrates,
a plurality of processing modules, each sized to receive a multi-disc carrier, at least on of said modules comprising a processing source for simultaneously applying a surface treatment process to a plurality of substrates within a dial carrier of a multi disc carrier positioned within said processing module.

2. The apparatus of claim 1 wherein said rotatable dial carrier holds at least three of said substrates.

3. The apparatus of claim 1 wherein said rotatable dial carrier holds at least six of said substrates.

4. The apparatus of claim 1 wherein said rotatable dial carrier holds at least ten of said substrates.

5. The apparatus of claim 1 wherein a plurality of said processing modules comprise processing sources for simultaneously applying a surface treatment process to a plurality of substrates within a dial carrier of a multi-disc carrier positioned within said processing module.

6. The apparatus of claim 1 wherein one of said processing modules comprises a processing source for applying a surface treatment process to fewer than all of the substrates within a dial carrier of a multi-disc carrier positioned within said processing module.

7. The apparatus of claim 6 wherein the dial carrier is rotated in an indexed fashion to apply said processing source in sequence to plural substrates within said dial carrier.

8. The apparatus of claim 1 wherein the processing modules are arranged in a sequential order for sequential processing of substrates passing therethrough in said multi-disc carrier.

9. The apparatus of claim 8 wherein the processing modules are assembled together in a linear configuration.

10. The apparatus of 8 further comprising a track, said multi-disc carriers being transported in cars along said track.

11. The apparatus of claim 8 wherein said processing modules are arranged in two vertical levels, and further comprising elevator stations for vertically moving a multi-disc carrier between said vertical levels.

12. The apparatus of claim 1 wherein said multi-disc carrier holds said substrates in a generally vertical orientation.

13. The apparatus of claim 1 wherein one said processing module comprises an actuator engageable to said multi-disc carrier to rotate said dial carrier.

14. The apparatus of claim 1 wherein one said processing module comprises a source having a normal direction, and an actuator engageable to said multi-disc carrier MDC to tilt said dial carrier to an angle relative to said normal direction.

15. The apparatus of claim 1 wherein an environment within at least one of said processing modules is isolated from an external atmosphere by a load lock.

16. The apparatus of claim 1 further comprising a robotic substrate handler for delivery or receipt of multi-disc carriers to or from said processing modules.

17. A mask enhancement process for generating patterned structures comprising
depositing a patterned photoresist material on a substrate,
hardening said photoresist material,
depositing a carbon spacer layer above said patterened photoresist,
removing said carbon spacer layer using an etch process that simultaneously etches said substrate to generate the desired patterned structure, and
removal of said hardened photoresist material.

18. The process of claim 17 wherein said step of depositing a carbon spacer layer creates greater accumulation of said spacer layer on said photoresist material than on portions of the substrate adjacent to the photoresist material.

19. A process of forming a magnetic disc media, comprising
etching a pattern of vertically-defined trenches in said media above a magnetic stack,
depositing a filler layer said vertically defined trenches utilizing a vapor phase deposition process to completely fill the trenches, and
planarizing the filler layer to fill said trenches.

20. The process of claim 19 wherein the step of depositing said filler layer comprises physical vapor deposition.

21. The process of claim 19 wherein the step of depositiong said filler layer comprises condensed phase deposition.

22. The process of claim 19 wherein said filler layer comprises a material selected from the group consisting of:
Aluminum oxide,
Silicon,
Silicon dioxide,
Silicon nitride,
Alpha-carbon, and
Carbon nitride.

23. A method of planarizing a magnetic media surface bearing trenches above a magnetic stack, comprising
depositing a bilayer of carbon of a selected thickness above said magnetic stack, covering said trenches and lands between said trenches,
depositing a silicon-containing filler layer above said carbon layer to fill said trenches and cover said lands to thereby form a surface above said trenches and lands,
selectively etching said filler layer in a process highly selective to the silicon-containing filler layer to remove said filler layer above said lands, leaving said filler layer within said trenches, recessed below an upper surface of said carbon bilayer a distance approximately equal to said selected thickness,
selectively etching said carbon layer in a process highly selective to the carbon layer, to remove exposed carbon on said lands and leave said trenches filled with said carbon layer and said silicon-containing layer.
